(19) United States
(12) Patent Application Publication
(10) Pub. No.: US 2025/0008452 A1
(43) Pub. Date: Jan. 2, 2025

(54) Synchronization for a Communication Node

(71) Applicant: Telefonaktiebolaget LM Ericsson (publ), Stockholm (SE)

(72) Inventors: Andreas Höglund, Solna (SE); Olof Liberg, Enskede (SE); Talha Khan, Santa Clara, CA (US)

(21) Appl. No.: 18/712,637

(22) PCT Filed: Nov. 23, 2022
(86) PCT No.: PCT/SE2022/051095

§ 371 Date: May 22, 2024

Related U.S. Application Data
(60) Provisional application No. 63/282,962, filed on Nov. 24, 2021.

(51) Int. Cl. H04W 56/00; H04W 52/02

(52) U.S. Cl. CPC H04W 56/001; H04W 52/0229

(57) ABSTRACT

A first communication node (12) monitors for a wake-up signal (20) during a wake-up signal occasion (20-O), and monitors for a synchronization signal (16) in a synchronization signal occasion (16-O). In one embodiment, the synchronization signal occasion (16-O) at least partially overlaps in time with the wake-up signal occasion (20-O). In another embodiments, the synchronization signal occasion (16-O) occurs in time before or after the wake-up signal occasion (20-O). In this latter case, the synchronization signal occasion (16-O) and the wake-up signal occasion (20-O) may be consecutive occasions in time or may have a gap in time between them. In case there is a gap in time between the occasions, the gap may be a function of a cell identifier, a carrier frequency, a numerology or subcarrier spacing, a periodicity of the wake-up signal occasion (20-O), and/or a discontinuous reception cycle length.

### TECHNICAL FIELD

The present application relates generally to communication nodes, and relates more particularly to synchronization between communication nodes.

### BACKGROUND

A wireless communication network transmits a paging message to a wireless communication device in order to trigger the device to connect to the wireless communication network, e.g., for receiving downlink user data. The paging message may for instance be transmitted over a downlink control channel, e.g., a Physical Downlink Control Channel (PDCCH). A wireless communication device in this case must monitor and decode the downlink control channel in order to determine whether any paging message is intended for the device. Such monitoring and decoding, however, consumes device power and negatively impacts device battery life.

Reduced power consumption can be realized by the use of a so-called wake-up signal (WUS). A wake-up signal is a signal that indicates a wireless communication device is to wake-up one or more receiver components, if needed, and monitor a downlink control channel, e.g., for any paging message intended for the device. A wake-up signal is designed so that it can be detected more quickly and/or without consuming as much power as compared to monitoring and decoding a downlink control channel. Exploiting a wake-up signal affords a wireless communication device more frequent opportunities to operate in a low power mode, e.g., in between occasions in which the device is to monitor for the wake-up signal.

Yet additional power conservation can be realized by using a so-called wake-up receiver (WUR) to monitor for and receive the wake-up signal. A wake-up receiver is a receiver that is capable of receiving a wake-up signal and that is separate from another receiver (referred to as a main receiver) which is woken up upon the wake-up receiver receiving the wake-up signal. The wake-up receiver's circuitry is less complex and/or more power efficient than the main receiver. This may mean that the main receiver is capable of receiving some signals or channels that the wake-up receiver cannot. For example, the main receiver may be capable of receiving one or more other signals or channels (e.g., PDCCH) needed for connecting to the wireless communication network, but the wake-up receiver may not be capable of receiving such signals or channels. Relieved of the need to receive the other signal(s) or channel(s), the wake-up receiver can be simplified and more power efficient than the main receiver. The wake-up receiver may for instance be dedicated for receiving the wake-up signal, and optionally, a synchronization signal. Or, even if not so dedicated, the wake-up receiver may be dedicated or tailored for receiving one or more signals or channels in a Radio Resource Control (RRC) idle state or an RRC inactive state, i.e., to the exclusion of one or more other signals or channels in an RRC connected state. In these and other cases, a wireless communication device may be equipped with both a wake-up receiver and another receiver (e.g., referred to as a main receiver) capable of receiving the other signal(s) or channel(s) that the wake-up receiver is not capable of receiving. The wireless communication device can then power down one or more components of its main receiver unless and until its wake-up receiver receives a wake-up signal.

Challenges nonetheless still exist in minimizing device power consumption and prolonging battery life. Indeed, even if a wireless communication device can use a wake-up receiver to reduce how often the device has to monitor a downlink control channel, a wireless communication device heretofore still must use its main receiver and tune to a different frequency than that of the wake-up signal in order to receive a synchronization signal, i.e., for time and/or frequency synchronization with the network. In 3GPP-based networks, for instance, a wireless communication device must still use its main receiver to receive a Primary Synchronization Signal (PSS) and a Secondary Synchronization Signal (SSS). Synchronization signal reception therefore threatens to limit the power conservation benefits achievable with a wake-up receiver.

### SUMMARY

One or more embodiments herein provide a synchronization signal that is receivable with receiver circuitry that is less complex and/or more power efficient as compared to existing synchronization signals. In fact, some embodiments enable a wireless communication device to receive a synchronization signal with a wake-up receiver, e.g., instead of the device's main receiver. One or more embodiments in this regard design and/or tailor a synchronization signal for reception by a wake-up receiver, e.g., so that time and/or frequency synchronization can be acquired through use of the wake-up receiver. Use of the wake-up receiver for synchronization in this regard helps the wireless communication device realize the full potential benefit of the wake-up receiver, e.g., in terms of power conservation.

More particularly, embodiments herein include a method performed by a first communication node. The method comprises monitoring for a synchronization signal from a second communication node.

In some embodiments, monitoring for a synchronization signal comprises monitoring for the synchronization signal in a synchronization signal occasion.

In some embodiments, the method further comprises monitoring for a wake-up signal during a wake-up signal occasion.

In one or more of these embodiments, the wake-up signal occasion and the synchronization signal occasion at least partially overlap in time. For example, the synchronization signal occasion may recur periodically in time with a period that is the same as, or is a multiple of, a period with which the wake-up signal occasion recurs periodically in time. In this case, at least one recurrence of the wake-up signal occasion at least partially overlaps in time with at least one recurrence of the synchronization signal occasion.

In other embodiments, the synchronization signal occasion occurs in time before the wake-up signal occasion. In one or more of these embodiments, the method further comprises detecting the synchronization signal and performing time and/or frequency synchronization based on the detected synchronization signal. In this case, monitoring for the wake-up signal comprises monitoring for the wake-up signal based on the performed time and/or frequency synchronization.

In other embodiments, the synchronization signal occasion occurs in time after the wake-up signal occasion. In one or more of these embodiments, the method further comprises detecting the wake-up signal during the wake-up signal occasion, in which case monitoring for the synchronization signal is performed after detecting the wake-up signal. The method may then further comprise detecting the synchronization signal as a result of monitoring for the synchronization signal, acquiring time and/or frequency synchronization based on the detected synchronization signal, and, responsive to detecting the wake-up signal, waking up one or more components of a receiver of the first communication node. The method may next further comprise making use of the acquired time and/or frequency synchronization when operating the receiver.

In some embodiments, the synchronization signal occasion and the wake-up signal occasion are consecutive occasions in time. In other embodiments, there is a gap in time between the synchronization signal occasion and the wake-up signal occasion. The gap may be a function of one or more of: a cell identifier identifying a cell on which the first communication node is to monitor for the synchronization signal, a carrier frequency on which the first communication node to is monitor for the synchronization signal, a numerology or subcarrier spacing with which the first communication node is to monitor for the synchronization signal, a periodicity of a wake-up signal occasion, or a discontinuous reception cycle length.

In some embodiments, the synchronization signal occasion recurs periodically in time with a period that is the same as a period with which the wake-up signal occasion recurs periodically in time. In one or more of these embodiments, the synchronization signal occasion recurs periodically in time with a period that is a multiple of a period with which the wake-up signal occasion recurs periodically in time.

In some embodiments, the method further comprises detecting the synchronization signal and, based on the detected synchronization signal, re-synchronizing with the second communication node to align a first time reference maintained by the first communication node with a second time reference maintained by the second communication node.

In some embodiments, the synchronization signal occasion is commonly associated with a set of multiple group-specific wake-up signal occasions during which wake-up signals are transmittable for respective groups of first communication nodes. In one or more of these embodiments, the synchronization signal occasion recurs periodically in time with a period that is a multiple of a period with which the set of multiple group-specific wake-up signal occasions recurs periodically in time.

In some embodiments, the synchronization signal occasion is associated with a group-specific wake-up signal occasion during which a wake-up signal is transmittable for a specific group of first communication nodes. In one or more of these embodiments, the synchronization signal occasion recurs periodically in time with a period that is a multiple of a period with which the group-specific wake-up signal occasion recurs periodically in time.

In some embodiments, the method further comprises determining a synchronization signal occasion during which to monitor for the synchronization signal. In one or more of these embodiments, determining the synchronization signal occasion comprises receiving information indicating the synchronization signal occasion. In one or more of these embodiments, the information is broadcasted System Information. In one or more of these embodiments, determining the synchronization signal occasion comprises determining the synchronization signal occasion based on one or more of a cell identifier identifying a cell on which the first communication node is to monitor for the synchronization signal, a carrier frequency on which the first communication node to is monitor for the synchronization signal, a numerology or subcarrier spacing with which the first communication node is to monitor for the synchronization signal, a periodicity of a wake-up signal occasion, or a discontinuous reception cycle length.

In some embodiments, the method further comprises detecting the synchronization signal, and performing time and/or frequency synchronization with the second communication node based on the detected synchronization signal.

In some embodiments, the method further comprises detecting a wake-up signal, and based on detecting the wake-up signal, waking up one or more components of a receiver of the first communication node.

In some embodiments, the synchronization signal is based on a concatenation of a pair of Zadoff-Chu sequences with different roots. In one or more of these embodiments, the synchronization signal is based on a pair of cyclic shifts applied to the pair of Zadoff-Chu sequences. In one or more of these embodiments, one Zadoff-Chu sequence in the pair is a complex conjugate of the other one of the Zadoff-Chu sequences in the pair. In one or more of these embodiments, the synchronization signal is based on a first cyclic shift of each Zadoff-Chu sequence in a first pair of Zadoff-Chu sequences, and a wake-up signal is based on a second cyclic shift of each Zadoff-Chu sequence in a second pair of Zadoff-Chu sequences. In one or more of these embodiments, the synchronization signal is generated from a single binary sequence.

In some embodiments, monitoring comprises monitoring for the synchronization signal in a synchronization signal occasion. In this case, the method further comprises monitoring for a wake-up signal during a wake-up signal occasion, wherein the synchronization signal occasion and the wake-up signal occasion occur in the same frequency region.

In some embodiments, monitoring comprises monitoring for the synchronization signal from the second communication node with a wake-up receiver of the first communication node.

In some embodiments, the first communication node is a wireless communication device.

In some embodiments, the first communication node is a network node in a wireless communication network.

In some embodiments, the second communication node is a network node in a wireless communication network.

In some embodiments, the second communication node is a wireless communication device.

In some embodiments, the method further comprises providing user data, and forwarding the user data to a host computer via the transmission to a base station.

Other embodiments herein include a method performed by a second communication node. The method comprises transmitting a synchronization signal to a first communication node.

In some embodiments, transmitting a synchronization signal comprises transmitting the synchronization signal in a synchronization signal occasion.

In some embodiments, the method further comprises transmitting a wake-up signal during a wake-up signal occasion.

In one or more of these embodiments, the wake-up signal occasion and the synchronization signal occasion at least partially overlap in time. For example, the synchronization signal occasion may recur periodically in time with a period that is the same as, or is a multiple of, a period with which the wake-up signal occasion recurs periodically in time, with at least one recurrence of the wake-up signal occasion at least partially overlapping in time with at least one recurrence of the synchronization signal occasion.

In other embodiments, the synchronization signal occasion occurs in time before the wake-up signal occasion. In still other embodiments, the synchronization signal occasion occurs in time after the wake-up signal occasion. In some embodiments, the synchronization signal occasion and the wake-up signal occasion are consecutive occasions in time. In other embodiments, there is a gap in time between the synchronization signal occasion and the wake-up signal occasion. The gap may be a function of one or more of: a cell identifier identifying a cell on which the first communication node is to monitor for the synchronization signal, a carrier frequency on which the first communication node to is monitor for the synchronization signal, a numerology or subcarrier spacing with which the first communication node is to monitor for the synchronization signal, a periodicity of a wake-up signal occasion, or a discontinuous reception cycle length.

In some embodiments, the synchronization signal occasion recurs periodically in time with a period that is the same as a period with which the wake-up signal occasion recurs periodically in time. In one or more of these embodiments, the synchronization signal occasion recurs periodically in time with a period that is a multiple of a period with which the wake-up signal occasion recurs periodically in time.

In some embodiments, the synchronization signal occasion is commonly associated with a set of multiple group-specific wake-up signal occasions during which wake-up signals are transmittable for respective groups of first communication nodes. In one or more of these embodiments, the synchronization signal occasion recurs periodically in time with a period that is a multiple of a period with which the set of multiple group-specific wake-up signal occasions recurs periodically in time.

In some embodiments, the synchronization signal occasion is associated with a group-specific wake-up signal occasion during which a wake-up signal is transmittable for a specific group of first communication nodes. In one or more of these embodiments, the synchronization signal occasion recurs periodically in time with a period that is a multiple of a period with which the group-specific wake-up signal occasion recurs periodically in time.

In some embodiments, the method further comprises transmitting, to the first communication node, information indicating a synchronization signal occasion during which the first communication node is to monitor for the synchronization signal. In one or more of these embodiments, the information is System Information, and wherein transmitting the information comprises broadcasting the information. In one or more of these embodiments, the information indicates the synchronization signal occasion by indicating one or more of a cell identifier identifying a cell on which the first communication node is to monitor for the synchronization signal, a carrier frequency on which the first communication node to is monitor for the synchronization signal, a numerology or subcarrier spacing with which the first communication node is to monitor for the synchronization signal, a periodicity of a wake-up signal occasion, or a discontinuous reception cycle length.

In some embodiments, the synchronization signal is based on a concatenation of a pair of Zadoff-Chu sequences with different roots. In one or more of these embodiments, the synchronization signal is based on a cyclic shift of each Zadoff-Chu sequence in the pair. In one or more of these embodiments, one Zadoff-Chu sequence in the pair is a complex conjugate of the other one of the Zadoff-Chu sequences in the pair. In one or more of these embodiments, the synchronization signal is based on a first cyclic shift of each Zadoff-Chu sequence in a first pair of Zadoff-Chu sequences, and a wake-up signal is based on a second cyclic shift of each Zadoff-Chu sequence in a second pair of Zadoff-Chu sequences. In one or more of these embodiments, the synchronization signal is generated from a single binary sequence.

In some embodiments, the synchronization signal occasion and the wake-up signal occasion occur in the same frequency region.

In some embodiments, the synchronization signal is receivable with a wake-up receiver of the first communication node.

In some embodiments, the first communication node is a wireless communication device.

In some embodiments, the first communication node is a network node in a wireless communication network.

In some embodiments, the second communication node is a network node in a wireless communication network.

In some embodiments, the second communication node is a wireless communication device.

In some embodiments, the method further comprises obtaining user data, and forwarding the user data to a host computer or a first communication node.

Embodiments herein also include corresponding apparatus, computer programs, and carriers of those computer programs.

Of course, the present disclosure is not limited to the above features and advantages. Indeed, those skilled in the art will recognize additional features and advantages upon reading the following detailed description, and upon viewing the accompanying drawings.

### BRIEF DESCRIPTION OF THE DRAWINGS

FIG. 1 is a block diagram of communication nodes according to some embodiments.

FIG. 2A is a block diagram of synchronization signal occasions according to some embodiments.

FIG. 2B is a block diagram of synchronization signal occasions according to other embodiments.

FIG. 2C is a block diagram of synchronization signal occasions according to still other embodiments.

FIG. 3 is a block diagram of synchronization signal occasions according to yet other embodiments.

FIG. 4A is a block diagram of synchronization signal occasions for wake-up signal groups according to some embodiments.

FIG. 4B is a block diagram of synchronization signal occasions for wake-up signal groups according to other embodiments.

FIG. 5 is a block diagram of wake-up signal timing according to some embodiments.

FIG. 6 is a logic flow diagram of a method performed by a first communication node according to some embodiments.

FIG. 7 is a logic flow diagram of a method performed by a second communication node according to some embodiments.

FIG. 8 is a block diagram of a first communication node according to some embodiments.

FIG. 9 is a block diagram of a second communication node according to some embodiments.

FIG. 10 is a block diagram of a communication system in accordance with some embodiments.

FIG. 11 is a block diagram of a user equipment according to some embodiments.

FIG. 12 is a block diagram of a network node according to some embodiments.

FIG. 13 is a block diagram of a host according to some embodiments.

FIG. 14 is a block diagram of a virtualization environment according to some embodiments.

FIG. 15 is a block diagram of a host communicating via a network node with a UE over a partially wireless connection in accordance with some embodiments.

### DETAILED DESCRIPTION

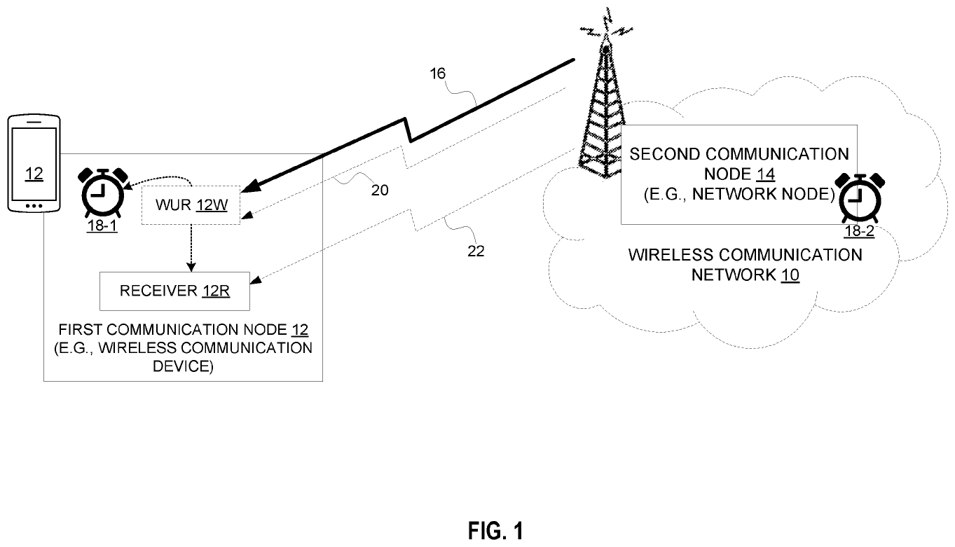

FIG. 1 shows a first communication node 12 and second communication node 14 according to some embodiments herein. In one embodiment as exemplified in FIG. 1, the first communication node 12 is a wireless communication device and the second communication node 14 is a network node in a wireless communication network 10. In another embodiment not shown, though, the first communication node 12 is a network node in a wireless communication network 10 and the second communication node 14 is a wireless communication device. In still another embodiment not shown, each of the first and second communication network nodes 12, 14 is a wireless communication device.

Regardless of the particular type of the communication nodes 12, 14, the second communication node 14 as shown transmits a synchronization signal 16 to the first communication node 12. The synchronization signal 16 is usable by the first communication node 12 for acquiring at least coarse time and/or frequency synchronization with the second communication node 14. Coarse time and/or frequency synchronization in this regard may be sufficient for receiving one or more signals or channels in an idle or inactive mode, e.g., where such signal(s) or channel(s) may for instance convey paging messages or System Information.

The synchronization signal 16 may more particularly be usable by the first communication node 12 for at least coarsely determining a time reference 18-2 maintained by the second communication node 14. This way, the first communication node 12 can at least coarsely align a time reference 18-1 that the first communication node 12 maintains with the time reference 18-2 that the second communication node 14 maintains. Alternatively or additionally, the first communication node 12 can at least roughly detect an offset between a frequency reference (not shown) maintained by the first communication node 12 and a carrier frequency on which the first and second communication nodes 12, 14 communicate. In one or more embodiments, the first communication node 12 does this as part of, or in order to, at least coarsely synchronize to a frame timing structure and/or a frequency raster usable for transmission between the first and second communication nodes 12, 14.

Some embodiments herein design the synchronization signal 16 to have certain advantageous properties. One or more embodiments, for example, design the synchronization signal 16 to minimize latency and/or frequency re-tuning. Alternatively or additionally, some embodiments design the synchronization signal 16 in such a way that it is receivable with receiver circuitry that is less complex and/or more power efficient as compared to existing synchronization signal designs.

FIG. 1 in this regard shows that some embodiments herein design the synchronization signal 16 so that it is receivable with a so-called wake-up receiver of the first communication node 12. More particularly, as shown in FIG. 1, the first communication node 12 has multiple receivers, including a receiver 12R (e.g., referred to as a ‘main’ receiver) as well as a wake-up receiver 12W. The receiver 12R is capable of receiving one or more signals or channels 22 needed for establishing a connection with the second communication node 14, e.g., a Physical Downlink Control Channel (PDCCH), and/or for user data reception. The receiver 12R may for instance be capable of receiving a Physical Downlink Control Channel (PDCCH), a Physical Downlink Shared Channel (PDSCH), and/or a Synchronization Signal Block (SSB), including a Primary Synchronization Signal (PSS) and a Secondary Synchronization Signal (SSS). The receiver 12R may therefore generally be usable for reception in an radio resource control (RRC) connected mode. The wake-up receiver 12W by contrast is capable of receiving a wake-up signal (WUS) 20. In some embodiments, the wake-up receiver 12W is not capable of receiving at least some of the one or more signals or channels 22 that the main receiver 12R is capable of receiving, e.g., the wake-up receiver 12W may not be capable of receiving the PDCCH and/or the PDSCH. The wake-up receiver 12W accordingly may be generally usable for reception in an RRC idle mode or an RRC inactive mode. Regardless, in some embodiments, the wake-up receiver 12W is simplified and more power efficient than the main receiver 12R.

In operation, then, when the first communication node 12 does not need to receive the one or more signals or channels 22, such as when the first communication node 12 is in an RRC idle or inactive mode, the first communication node 12 operates the receiver 12R in a power-saving or sleep state, e.g., by powering down one or more components of the receiver 12R. During this time, though, the wake-up receiver 12W monitors for the wake-up signal 20. Reception of the wake-up signal 20 indicates to the first communication node 12 that the receiver 12R needs to be awaken in order to monitor for the one or more signals or channels 22. That is, the wake-up signal 20 indicates to wake-up one or more components of the receiver 12R. Accordingly, responsive to detecting the wake-up signal 20, the wake-up receiver 12W wakes up the one or more components of the receiver 12R, whereupon the receiver 12R monitors for the one or more signals or channels 22.

In these and other embodiments, the wake-up receiver 12W is advantageously usable for receiving both the wake-up signal 20 and the synchronization signal 16. This means that the first communication node 12 need not wake up component(s) of the receiver 12R in order to receive either the wake-up signal 20 or the synchronization signal 16, but instead can keep the receiver 12R in a power-saving or sleep state.

In some embodiments, for example, the first communication node 12 makes use of synchronization acquired from the synchronization signal 16 for operating the wake-up receiver 12W and for receiving the wake-up signal 20 with that wake-up receiver 12W. Rather than having to occasionally or periodically wake up components of the receiver 12R for receiving the synchronization signal 16, then, the first communication node 12 can keep those receiver components asleep unless and until the wake-up signal 20 is received. Alternatively or additionally, the first communication node 12 may make use of synchronization acquired from the synchronization signal 16 for operating the receiver 12R, e.g., the synchronization acquired using the wake-up receiver 12W is used for operating the receiver 12R.

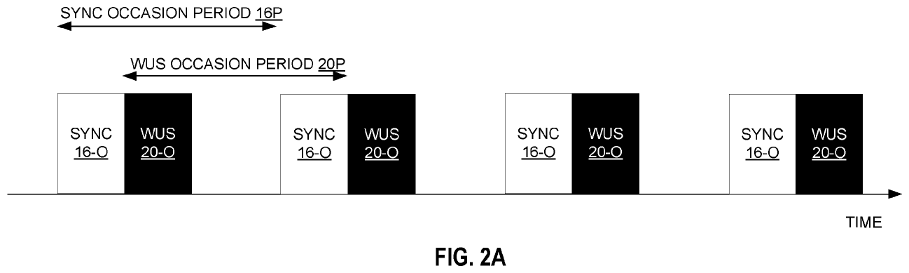

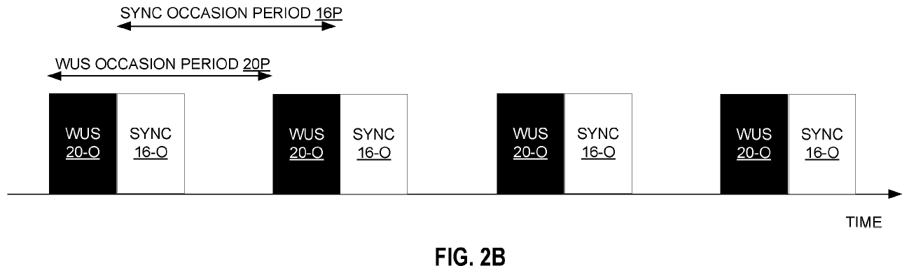

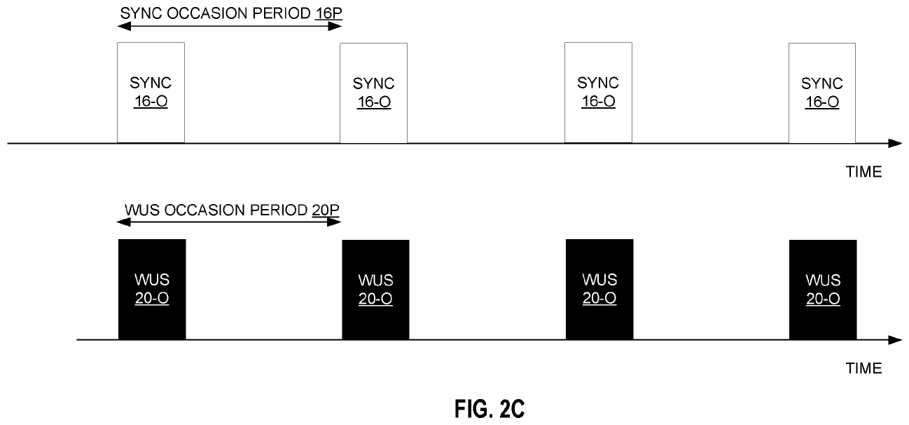

FIG. 2A shows one example configuration for making use of the synchronization acquired from the synchronization signal 16 for operating the wake-up receiver 12W. As shown, the synchronization signal 16 is transmittable in certain occasions 16-O in time, referred to as synchronization signal occasions 16-O. In one embodiment, these synchronization signal occasions 16-O recur periodically in time, e.g., with a period 16P. The first communication node 12 accordingly monitors for the synchronization signal 16 in such occasions 16-O, e.g., with the wake-up receiver 12W. FIG. 2A also shows that the wake-up signal 20 is transmittable in other occasions 20-O in time, referred to as wake-up signal occasions 20-O. In one embodiment, these wake-up signal occasions 20-O recur periodically in time, e.g., with a period 20P. The first communication node 12 accordingly monitors for the wake-up signal 20 in such occasions 20-O, e.g., with the wake-up receiver 12W.

As shown in this example, the period 16P with which the synchronization signal 16 recurs is the same as the period 20P with which the wake-up signal 20 recurs. And each synchronization signal occasion 16-O occurs adjacent to and immediately before one of the wake-up signal occasions 20-O, i.e., with no time gap therebetween. The first communication node 12 in this case receives the synchronization signal 16 in a synchronization signal occasion 16-O, acquires synchronization from the received synchronization signal 16, and makes use of that synchronization when operating the wake-up receiver 12W to monitor for the wake-up signal 20 in the very next wake-up signal occasion 20-O. This thereby allows the first communication node 12 to synchronize before each attempt to detect the wake-up signal 20.

FIG. 2B by contrast shows an example configuration for making use of the synchronization acquired from the synchronization signal 16 for operating receiver 12R. As compared to FIG. 2A, each synchronization signal occasion 16-O occurs adjacent to and immediately after one of the wake-up signal occasions 20-O, i.e., with no time gap therebetween. The first communication node 12 in this case receives the synchronization signal 16 in a synchronization signal occasion 16-O, acquires synchronization from the received synchronization signal 16, and makes use of that synchronization if and when operating the receiver 12R thereafter. This thereby allows the first communication node 12 to synchronize in case it detects the wake-up signal 16. In a context where the first communication node 12 is a wireless communication device and the second communication node 14 is a network node, this advantageously enables the first communication node 12 to only monitor the synchronization signal occasion 16-O if the first communication node 12 receives a wake-up signal 20 indicating the first communication node 12 will be paged in the downlink (resulting in reduced energy consumption).

Regardless of whether the synchronization signal occasions 16-O occur before or after the wake-up signal occasions 20-O, each synchronization signal occasion 16-O shown above is adjacent to one of the wake-up signal occasions 20-O, i.e., with no time gap therebetween. This is a power efficient way to monitor for the synchronization signal 16 and wake-up signal 20, especially in embodiments where the first communication node 12 uses the wake-up receiver 12W to monitor for those signals 16, 20 and powers down component(s) of the wake-up receiver 12W when the signals 16, 20 are not expected. By having the synchronization signal occasion 16-O as close to the wake-up signal occasion 20-O as possible, the time that the wake-up receiver 12W must keep its component(s) of the wake-up receiver 12W powered on is minimized. Indeed, this approach avoids the first communication node 12 having to wake up components of the wake-up receiver 12W much earlier than the wake-up signal occasion 20-O in order to synchronize to the downlink. Moreover, even in embodiments where the synchronization signal occasion 16-O occurs immediately after the wake-up signal occasion 20-O, this approach still proves more power efficient than if the first communication node 12 were to use receiver 12R for receiving the synchronization signal 16, since doing so would consume energy akin to a cold start of the receiver 12R, which could take several seconds.

That said, some embodiments nonetheless introduce a time gap between at least one wake-up signal occasion 20-O and its closest synchronization signal occasion 16-O. Such time gaps may for instance be exploited to accommodate for one or more other design considerations, e.g., synchronization signals for multiple different communication node groups or for multiple cells (discussed further below).

FIG. 2C by contrast shows yet other embodiments herein where at least one (e.g., each) synchronization signal occasion 16-O at least partially overlaps in time with at least one of the wake-up signal occasions 20-O. In these embodiments, then, the synchronization signal 16 is transmittable in at least one (e.g., each) wake-up signal occasion 20-O during which no wake-up signal 20 is transmitted. By receiving the synchronization signal 16 during such occasions, the first communication node 12 can re-synchronize with the second communication node 14, e.g., to align the time reference 18-1 maintained by the first communication node 12 with the time reference 18-2 maintained by the second communication node 14. This can help combat drift in the alignment of the time references 18-1, 18-2 over time. Advantageously, with the occasions 16-O, 20-O at least partially overlapping in time, less on-time (during which receiver components are powered on) is needed for synchronization than if the occasions 16-O, 20-O did not overlap at all in time. In fact, in embodiments where the occasions 16-O, 20-O fully overlap in time, the first communication node 12 need only power on its receiver components for the duration of a single occasion 16-O or 20-O.

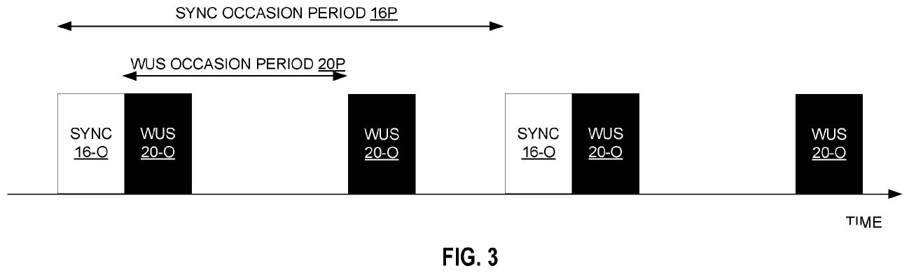

Although the above examples show wake-up signal occasions 20-O recurring just as often as synchronization signal occasions 16-O, other embodiments herein configure synchronization signal occasions 16-O to recur less often that wake-up signal occasions 20-O, in the interest of reducing the overhead due to the synchronization signal 16. For example, if the time and/or frequency drift is small enough that the first communication node 12 need not synchronize before each wake-up signal detection attempt, the period 16P with which the synchronization signal 16 recurs may be a multiple of the period 20P with which the wake-up signal 20 recurs, e.g., the synchronization signal occasions 16-O are only associated with a subset of the wake-up signal occasions 20-O. FIG. 3A for instance shows one embodiment wherein the synchronization signal period 16P is twice as long as the wake-up signal period 20P. In this case, the first communication node 12 may make use of the synchronization acquired from the synchronization signal 16 when operating the wake-up receiver 12W to monitor for the wake-up signal 20 in the next two wake-up signal occasions 20-0, before re-acquiring synchronization with the synchronization signal 16 in the next synchronization signal period 16P. Other configurations are of course possible, e.g., the synchronization signal occasions 16-O may only recur ever 10^{th} wake-up signal occasions 20-O.

Note also that the above schemes can be combined in any manner. For example, in one embodiment, a synchronization signal occasion 16-O occurs in (i.e., overlaps with) every 10^{th} wake-up signal occasion 20-O occasion, and immediately follows after any wake-up signal occasion 20-O during which a wake-up signal 20 is transmitted. The synchronization signal occasions 16-O that occur during a wake-up signal occasion 20-O would then ensure that the first communication node 12 can re-synchronize during long periods without data activity, and the synchronization signal occasions 16-O that occur after a wake-up signal occasion 20-0 would ensure that the first communication node 12 can synchronize before monitoring paging or starting any other legacy procedure.

Especially if the synchronization signal 16 is used for re-synchronization, how often the synchronization signal 16 is transmitted may depend on a discontinuous reception (DRX) cycle length (i.e., wake-up signal occasion periodicity) of the first communication node 12. If DRX is short, the synchronization signal 16 in some embodiments appears in association to a lower number of wake-up signal occasions 20-O, e.g., in every 100^{th} wake-up signal occasion for a DRX cycle of 100 ms but in every 10^{th} wake-up signal occasion for a DRX cycle of 1000 ms. This could either be implicit, e.g., the first communication node 12 would notice if the synchronization signal 16 is present from blind decoding, or it could be explicitly configured as part of the wake-up receiver configuration in the cell.

In some embodiments, which scheme is used may be hard-coded in a governing communication specification, or be configured by the network 10, e.g. via common Radio Resource Control (RRC) signaling in System Information.

In some embodiments involving wireless communication network 10, for example, the network 10 can configure one of the different possible configurations discussed above (e.g., in FIGS. 2A-2C) for the position of the synchronization signal 16 and the wake-up signal 20, e.g., on a cell by cell basis. If the possible configurations are specified in a communication specification (e.g., a 3GPP specification) but not signaled to the first communication node 12, the first communication node 12 may hypothesize different positions for the synchronization signal 16 relative to that of the wake-up signal 20 until it detects the synchronization signal. The first communication node 12 can learn the configuration at the expense of increased receiver processing. Alternatively, the configuration can be broadcast in a cell, e.g., in System Information, and the first communication node 12 can learn it during initial synchronization/initial attach. Yet another alternative is to tie this configuration to other information, e.g., Physical Cell Identity (PCID), in which case the first communication node 12 will implicitly learn the configuration when it learns the other information during initial synchronization.

As one example, the network 10 may configure each synchronization occasion 16-O to occur immediately before a wake-up signal occasion 20-O for one cell, as in FIG. 2A, and configure each synchronization occasion 16-O to occur immediately after a wake-up signal occasion 20-O for a neighboring cell, as in FIG. 3. As the time-domain location of the synchronization signal 16 is non-overlapping in the two neighboring cells, the synchronization signal 16 will be less prone to inter-cell interference. Moreover, identical synchronization signals can be used in both cells.

In other embodiments, different cells configure different time gaps between the synchronizations signal 16 and the wake-up signal 20, e.g., such that the time gaps help separate the signals 16, 20 in different cells. The time gaps may for instance be specified in terms of a number of time slots. In one embodiment, the time gap for each cell is assigned based on a cell characteristic, such as the PCID, possibly in combination with other characteristics, such as the carrier frequency of that cell. As a result, the first communication node 12 automatically learns the relative position of the synchronization signal 16 and wake-up signal 20 in the cell during initial synchronization. Moreover, this also facilitates assigning non-overlapping configurations in the time domain-which reduces inter-cell interference for the synchronization signal 16 and also paves the way for using the same synchronization signal 16 in different neighbor cells (otherwise orthogonal synchronization signals, or synchronization signals with sufficiently low cross-correlation, may be needed to avoid inter-cell interference). In still other embodiments, different time gap ranges can be defined for different numerologies, carrier frequencies, groups of communication nodes, etc.

Some embodiments in this regard configure the synchronization signal 16 to be receivable by as many communication nodes as possible, so that the synchronization signal 16 does not have to be repeated unnecessarily. These embodiments balance desired overhead reduction with minimization of communication node energy consumption. That is, from a signaling overhead point of view it is preferred to have a synchronization signal which is acquired by all communication nodes and not connected to any paging occasions (POs) or wake-up signal occasion. From the communication node energy consumption point of view, on the other hand, it is preferable for a communication node to wake up from any sleep mode, e.g., eDRX, just before its paging occasion or wake-up signaling occasion to synchronize.

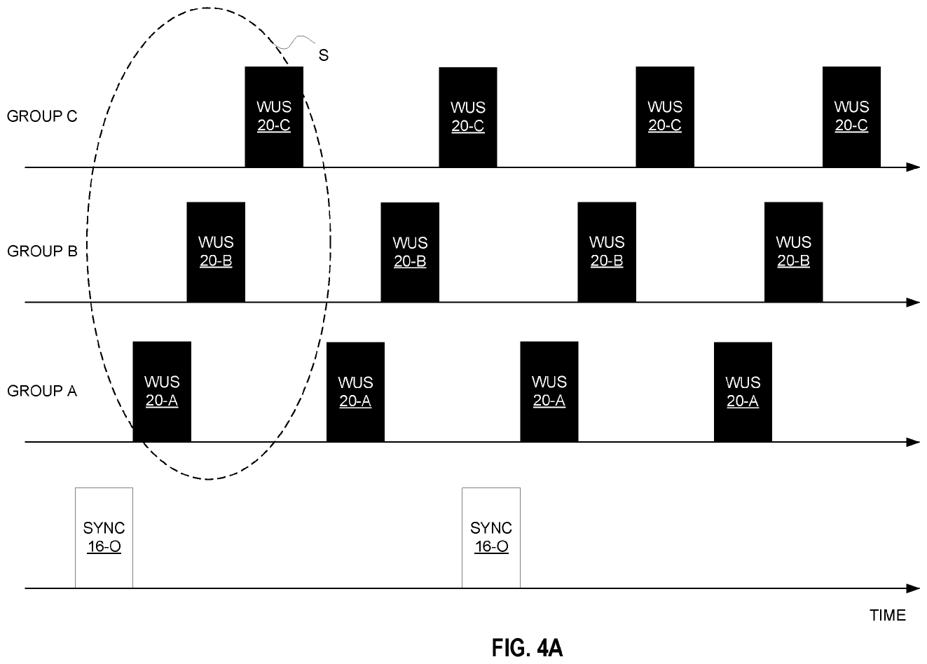

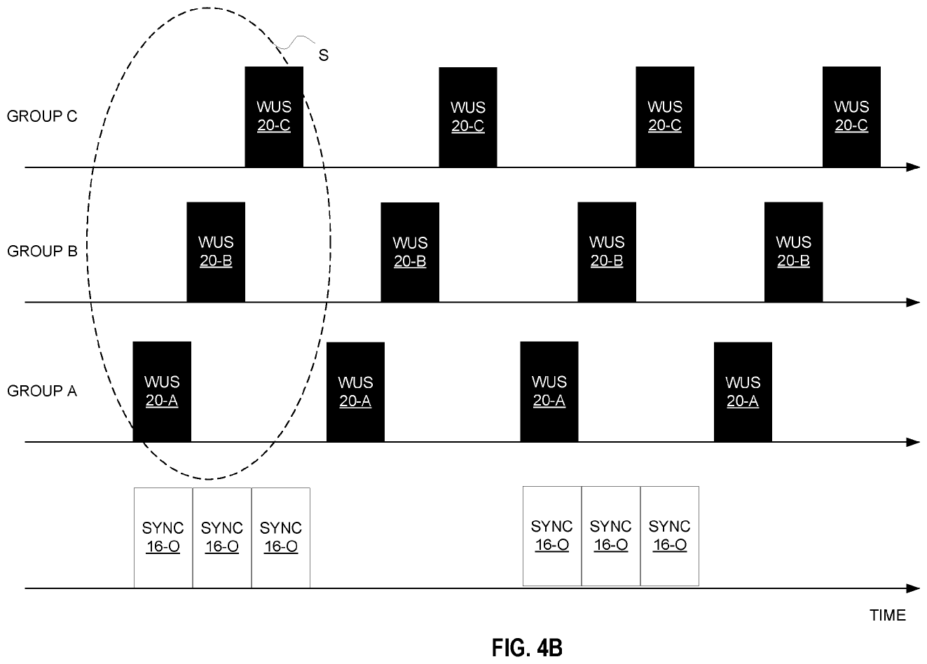

Accordingly, in some embodiments, a synchronization signal occasion 16-O is commonly associated with a set of multiple group-specific wake-up signal occasions during which wake-up signals are transmittable for respective groups of first communication nodes. FIG. 4A shows for example that a group A of communication nodes is configured with group-specific wake-up signal occasions 20-A during which wake-up signals 20 are transmittable for group A, group B of communication nodes is configured with group-specific wake-up signal occasions 20-B during which wake-up signals 20 are transmittable for group B, and group C of communication nodes is configured with group-specific wake-up signal occasions 20-C during which wake-up signals 20 are transmittable for group C. In this case, each synchronization signal occasion 16-O is commonly associated with a set S of multiple of multiple group-specific wake-up signal occasions 20-A, 20-B, and 20-C.

In one embodiment, wake-up signal occasions for different groups are allocated or assigned based on e.g., a uniform/quasi-random distribution, based on communication node ID, or based on a wake-up signal gap communication node capability. In another embodiment, wake-up signal occasions for different groups are bundled to be associated to synchronization signal occasions. For instance, in some embodiments as shown in FIG. 4A, there is one synchronization signal mapped to all wake-up signal occasions belonging to the different groups. In other embodiments, as shown in FIG. 4B, there is one synchronization signal per wake-up signal group. In the latter case, a given communication device may use any of the synchronization signal transmissions, e.g., a communication node in good coverage would only use the synchronization signal which is closest in the time domain to its wake-up signal occasion, but a communication node in poor coverage may also have to accumulate the repetitions farther from its wake-up signal occasion.

Consider now the design of the synchronization signal 16 according to some embodiments. In some embodiments, the synchronization signal 16 serves as an indication of available network coverage provided by a specific access point. In this embodiment, the synchronization signal 16 is designed to be detectable at a low signal to noise and interference ratio (SINR). In one embodiment, the synchronization signal 16 also serves as an identification of the access point. Alternatively or additionally, the synchronization signal 16 may function as a time and/or frequency reference that allows the first communication node 10 to synchronize to a downlink frame structure and/or to a downlink frequency raster provided by the access point.

In some embodiments, the synchronization signal is formed from a Zadoff Chu sequence, e.g., which has a flexible length and good auto-correlation and cross-correlations properties. In particular, in some embodiments, a Zadoff Chu sequence is orthogonal to a time shifted version of the sequence. Also, a Zadoff Chu sequence defined by a first root has low cross-correlation with a second Zadoff Chu sequence defined by a second root. These properties allow a device to synchronize to the sequence in time, and also to distinguish a specific Zadoff Chu sequence transmitted from a specific access point from a set of possible Zadoff Chu sequences transmitted from other access points. The length of the sequence can be said to correspond to the power the sequence is transmitted with and can be selected sufficiently long to facilitate detection at a desired SINR. A Zadoff Chu sequences also supports frequency synchronization and detection of frequency offsets in the local frequency reference hosted by the communication node in comparison to the carrier frequency of a received Zadoff Chu sequence. A Doppler shift in frequency of the received Zadoff Chu sequence will however distort its excellent auto correlation properties.

According to some embodiments herein, the synchronization signal 16 is based on a concatenation of a pair of Zadoff-Chu sequences with different roots, e.g., one Zadoff-Chu sequence in the pair is tacked onto the end of the other Zadoff-Chu sequence in the pair. For example, in some embodiments, the synchronization signal 16 is based on a pair of concatenated Zadoff Chu (ZC) sequences using unique and different roots 11 and 2. Sets of distinct ZC sequences can be generated by means of using multiple unique root pairs. Although the ZC sequences with different roots are not orthogonal, they do exhibit a low cross-correlation. The ZC sequences obtained via cyclic shifts of a ZC root sequence, however, are orthogonal. Therefore, orthogonal ZC sequences can be generated by cyclic shifts of the concatenated sequences. With this design, a large set of orthogonal WUS can be generated based on the concatenated ZC sequences. This design can also be exploited for the synchronization signal 16 thanks to the excellent frequency error resilience it offers even towards high Doppler shifts which may deteriorate the performance of a single Zadoff Chu sequence based synchronization signal.

In one embodiment, the synchronization signal 16 signal is designed by using a pair of ZC sequences of length n₁ and n₂ and roots μ₁ and μ₂, respectively. In a sub-embodiment, n₁=n₂=n and μ₁=n−μ₂ mod n such that one sequence is the complex conjugate of the other. This simplification enables a lower-complexity processing for detecting the delay and the carrier frequency offset (CFO) at the wake-up receiver 12W.

More particularly, for ease of exposition, assume n=n₁=n₂ in the following. There are n−1 unique root sequences possible for a sequence of length n when n is a prime number. When each synchronization signal 16 is based on a pair of ZC sequences using two unique roots, there are U unique root synchronization signals possible where each synchronization signal is generated using a unique root pair, and floor (⋅) is the integer floor function.

Note that there are up to

$$\frac{( n - 1 ) \times ( n - 2 )}{2}$$

unique root synchronization signals possible such that no two root synchronization signals have the same root pairs. In some embodiments, for each root synchronization signal with roots μ₁ and μ₂, one may also consider its “mirror image” synchronization signal (i.e., the synchronization signal with roots μ₂ and μ₁) as a distinct synchronization signal even though both have the same root pairs. If mirror images are considered, then there can be up to (n−1)×(n−2) unique root synchronization signals possible.

In another embodiment, the second sequence can be obtained by taking a complex conjugate of the first sequence. In this special case, the root of the second sequence is given by μ₂=n−μ₁ mod n, where n is the sequence length and modulo arithmetic is assumed. As a result, each synchronization signal can be uniquely identified by specifying only a single root μ₁ since the second root is a known function of the first root.

There are up to

$$\frac{( n - 1 )}{2}$$

unique root synchronization signals possible where each synchronization signal is generated using a unique root pair. Note that if considering the mirror image of each root synchronization signal as a distinct synchronization signal, then there can be up to (n−1) unique root synchronization signals possible.

For each unique root synchronization signal, it is possible to further generate up to V orthogonal synchronization signals (including the root synchronization signal) by cyclically shifting the root synchronization signal. All such sequences will correspond to the same root pair. In particular, cyclically shifting a root synchronization signal means that each constituent ZC sequence of the root synchronization signal is cyclically shifted by a certain amount, i.e., sequence 1 shifted by c_1 samples while sequence 2 shifted by c_2 samples, where c_1 and c_2 may or may not be the same.

Note that for a length n ZC sequence, the cyclic shift from 0, . . . , n−1 yield n orthogonal ZC sequences where a cyclic shift of 0 corresponds to the root ZC sequence. Further note that a root WUR SYNC is constructed from 2 length n ZC sequences. If the same cyclic shift value is applied to both sequences, a root synchronization signal can be used to generate up to n orthogonal synchronization signal including the root synchronization signal. If cyclic shift values for both sequences are not restricted to be the same and can be chosen independently of each other, a root synchronization signal can be used to generate up to n² orthogonal synchronization signal including the root synchronization signal. In total, there can be up to W=U×V unique synchronization signal where all the synchronization signals generated from the same root synchronization signal are orthogonal. The synchronization signal generated from different root synchronization signals will not typically be orthogonal but are expected to have a low cross-correlation.

In another embodiment, the synchronization signal 16 can be generated by concatenating two ZC sequences in the time domain, by concatenating two ZC sequences in the frequency domain, or by jointly transmitting two ZC sequences using the same time/frequency resources. For efficient processing, the first communication node 12 needs to know the time-domain and/or frequency domain structure of the synchronization signal generated in this way. This can be either fixed in a governing communications specification or signaled by the network 10, e.g., using System Information.

In another embodiment, the synchronization signal 16 is fixed in a governing communications specification (i.e., roots and cyclic shift values are specified) and the same synchronization signal is used in all cells. In yet another embodiment, more than one possible value for the roots and cyclic shifts are specified in the governing communications specification, i.e., different synchronization signals are specified and the network 10 configures one such synchronization signal in a cell. The network 10 can indicate this information explicitly in the SI. Alternatively, the synchronization signal 16 configured in the cell can be tied to a cell characteristic such as PCID, and the first communication node 10 learns it implicitly during initial synchronization.

In some embodiments, to distinguish between a wake-up signal 20 for waking up the receiver 12R and the synchronization signal 16, dedicated sets of ZC roots and/or ZC cyclic shifts can be assigned to the wake-up signal 20 and to the synchronization signal 16. The network 10 can then configure the first communication node 12 to monitor for a synchronization signal 16 that is based on a first unique root pair and cyclic shift combination, and to monitor for a wake-up signal 20 that is based on a second unique root pair and cyclic shift combination.

Note that both signals 16, 20 can still be used by the wake-up receiver 12W to acquire synchronization. For example, in some embodiments, the synchronization signal 16 and the wake-up signal 20 both are transmitted using the same time/frequency resources and have the same structure with distinct roots and/or cycle shifts. Both signals 16, 20 can be used to acquire synchronization. The first communication node 12 monitors the synchronization signal occasion 16-O to determine whether the received signal is a wake-up signal or synchronization signal.

In yet another embodiment, the synchronization signal 16 is derived from a Primary Synchronization Signal (PSS) and/or a Secondary Synchronization Signal (SSS) that is receivable by receiver 12R. To reduce the receiver detection complexity, the used synchronization signal can furthermore be based on a single binary or complex sequence. In case of binary M-sequence based signals such as the New Radio (NR) PSS, this can be achieved by configuring the wake-up receiver 12W to detect a PSS based on a known M-sequence defined by a known cyclic shift. In case of complex ZC-sequence based signals such as the Long Term Evolution (PSS), this can be achieved by configuring the wake-up receiver 12W to detect a PSS based on a known ZC-sequence defined by a known root and cyclic shift. The mentioned PSS or SSS based synchronization signal can also be configured in the same frequency range as the wake-up signal 20 for the purpose of providing synchronization to a wake-up receiver 12W without requiring the wake-up receiver 21W to switch frequency when monitoring for the wake-up signal 20 and when monitoring for the synchronization signal 16. PSS and SSS based synchronization signals can be configured in conjunction to each other similarly as done for PSS and SSS designs.

Note that in some embodiments the first communication node 12 operates the wake-up receiver 12W continuously, i.e., the first communication node 12 has the wake-up receiver 12W on all the time and is not applying any duty-cycle or DRX. In this case, the first communication node 12 may omit acquisition of the synchronization signal broadcast. In one embodiment, the support of continuous wake-up receiver 12W operation in a cell may be implicit from the lack of broadcast of the synchronization signal 16.

Note that, in some embodiments, the wake-up signal 20 and the synchronization signal 16 are transmitted in the same time-frequency resources. In this case, the signals 16, 20 may be separated in the physical layer signals or in the signal content (e.g., in the header). In other embodiments, by contrast, the wake-up signal 20 and the synchronization signal 16 are transmitted in different time-frequency resources. In one embodiment, for example, the wake-up signal 20 and the synchronization signal 16 are frequency multiplexed.

In some embodiments, the synchronization signal 16 provides enough synchronization accuracy also for receiver 12R upon connection setup and data transmission, e.g., meaning the first communication node 12 need not receive PSS/SSS. In other embodiments, by contrast, the synchronization signal 16 is used for synchronization of the wake-up receiver 12W only and for checking paging or performing other idle mode activities, e.g., reading some System Information or simplified SSB. In this case, upon connection setup and data transmission, the first communication node 12 may acquire PSS/SSS (e.g., as part of SSB) with receiver 12R. Note, though, that the synchronization signal 16 may still be helpful if the wake-up signal or eDRX period is long and the first communication node 12 is really out of synchronization initially. This may prove true especially if the first communication node 12 is to read the SSB anyway in order to check if the cell being accessed is barred.

Note further that although some embodiments herein have been described in a context where the first communication node 12 uses a wake-up receiver 12W for receiving the synchronization signal 16, embodiments herein are not limited to that case. In other embodiments, for example, the first communication node 12 may use any receiver for receiving the synchronization signal 16, e.g., the first communication node 12 may use receiver 12R for receiving both the synchronization signal 16 and the wake-up signal 20. In these and other embodiments, the synchronization signal 16 and the wake-up signal 20 may be transmitted on the same frequency, or in the same frequency range, to avoid or minimize frequency re-tuning.

Note also that although embodiments may be applied for a New Radio (NR) network, embodiments herein may be equally applicable to LTE (e.g. NB-IoT or LTE-M) or any 6G network.

Some embodiments herein are applicable in the following context. In some embodiments, receiver 12R is a baseband receiver and/or a receiver that consumes higher power than wake-up receiver 12W. The wake-up receiver 12W wakes up receiver 12R to detect an incoming message, e.g., a paging message such as a message on PDCCH in paging occasions or a message scheduling the paging message on PDSCH. One benefit of this is lower energy consumption and longer device battery life, or at a fixed energy consumption the downlink latency can be reduced (shorter DRX/duty-cycles and more frequent checks for incoming transmissions).

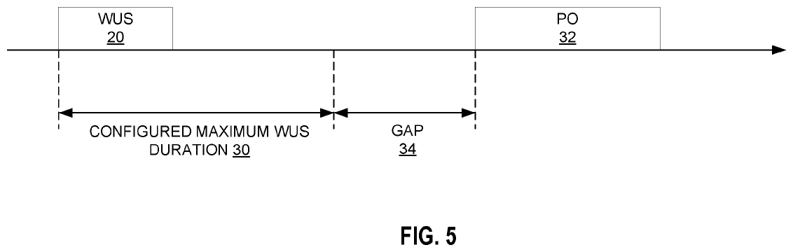

Some embodiments for example are applicable to or based on a Rel-15 WUS, e.g., as specified for Narrowband Internet of Things (NB-IoT) and Long Term Evolution for Machines (LTE-M). One motivation is energy consumption reduction since with coverage enhancement PDCCH may be repeated many times and the WUS is relatively shorter and hence requires less reception time. In this case, the wake-up receiver 12W checks for a WUS a certain time before the first communication node's paging occasion (PO), and only if a WUS is detected, the first communication node 12 continues to check for PDCCH in the PO, and if not, which is most of the time, to first communication node 12 can go back to a sleep state to conserve energy. Due to the coverage enhancements, the WUS can be of variable length depending on the first communication node's coverage. FIG. 5 shows one example in this regard. In such a case, a wake-up signal occasion 30 as used herein may span the configured maximum wake-up signal duration 32. In one such embodiment shown, there may be a gap 36 in time between the end of the maximum WUS duration 32 and the next PO 34.

In these and other embodiments the wake-up signal 20 may be based on the transmission of a short signal that indicates to the first communication node 10 that it should continue to decode a downlink control channel, e.g., full Narrowband PDCCH (NPDCCH) for Narrowband Internet of Things (NB-IoT). If such signal is absent (discontinuous transmission, DTX, i.e., the first communication node 12 does not detect it) then the first communication node 12 can go back to sleep without decoding the downlink control channel. The decoding time for the wake-up signal 16 may be considerably shorter than that of the full NPDCCH since it essentially only needs to contain one bit of information whereas the NPDCCH may contain up to 35 bits of information. This, in turn, reduces power consumption and leads to longer battery life. The wake-up signal 20 in some embodiments is transmitted only when there is paging for the first communication node 12. But if there is no paging for the first communication node 12 then the wake-up signal 20 will not be transmitted (i.e., implying a discontinuous transmission, DTX) and the first communication node 12 would go back to sleep, e.g., upon detecting DTX instead of the wake-up signal 20.

In some embodiments, though, the wake-up signal 20 is not PDCCH-based. Rather, the wake-up signal 20 is designed for reception by a simpler and low power receiver, i.e., wake-up receiver 12W. The wake-up signal 20 may for example be based on on-off keying (OOK) modulation and non-coherent detection.

In this context, some embodiments herein use only the wake-up receiver 12W for both the wake-up signal 20 and the synchronization signal 16, i.e., only the wake-up receiver 12W is needed for time and frequency synchronization. The synchronization signal 16 in this regard may be tailored to provide time-frequency synchronization for a low complexity, energy efficient receiver. This allows the first communication node 12 to keep track of time and frequency in a very power efficient manner, and ensures that for use cases with infrequent traffic, which is the case for many IoT applications, the first communication node 12 needs only use the wake-up receiver 12W most of the time, and only turn on the main receiver 12R in the relatively rare/infrequent event of user-plane data transmission. Alternatively or additionally, some embodiments herein allow the first communication node 12 to avoid switching between a first frequency range where the synchronization signal 16 is broadcasted and a second frequency range where the wake-up signal 20 is provided in conjunction with a paging occasion. This reduces the communication node implementation complexity and is one step towards the support of a low complexity, energy-efficient wake-up receiver design. Some embodiments herein furthermore allow the first communication node 12 to keep track of time to maintain an accurate clock. Time keeping is a vital function in many IoT applications and it is advantageous to provide this service in a power efficient manner. Alternatively or additionally, some embodiments herein are robust to large carrier frequency offsets, e.g., some embodiments permit the wake-up receiver 12W to have a low quality oscillator with a large frequency drift.

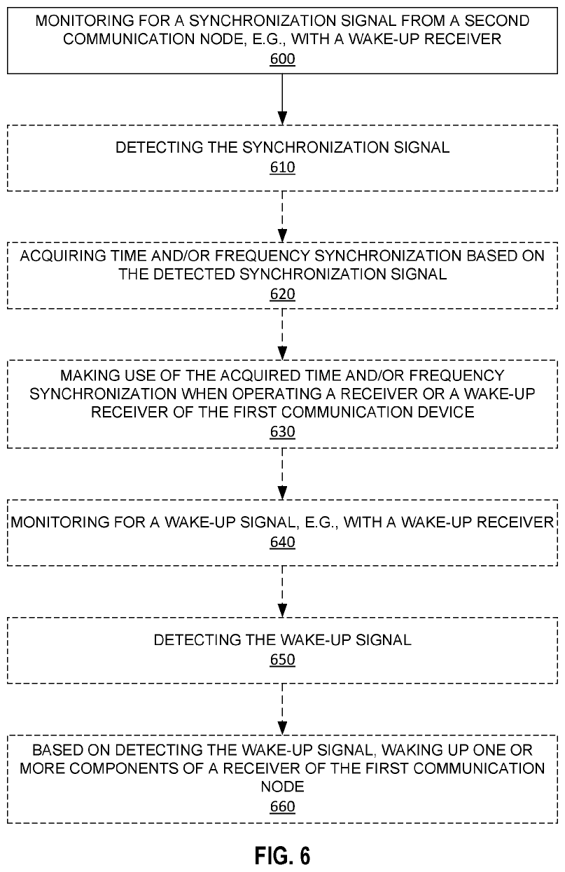

In view of the modifications and variations herein, FIG. 6 depicts a method performed by a first communication node 12. The method comprises monitoring for a synchronization signal 16 from a second communication node 14 (600).

In some embodiments, monitoring for a synchronization signal 16 comprises monitoring for the synchronization signal 16 in a synchronization signal occasion 16-O.

In some embodiments, the method further comprises monitoring for a wake-up signal 20, e.g., during a wake-up signal occasion 20-O (Block 640). In one or more of these embodiments, the wake-up signal occasion 20-O and the synchronization signal occasion 16-O at least partially overlap in time. In one or more of these embodiments, the synchronization signal occasion 16-O recurs periodically in time with a period that is the same as, or is a multiple of, a period with which the wake-up signal occasion 20-O recurs periodically in time. In one embodiment, at least one recurrence of the wake-up signal occasion 20-O at least partially overlaps in time with at least one recurrence of the synchronization signal occasion 16-O. In one or more of these embodiments, the method further comprises detecting the synchronization signal 16 and, based on the detected synchronization signal 16, re-synchronizing with the second communication node 14 to align a first time reference 18-1 maintained by the first communication node 12 with a second time reference 18-2 maintained by the second communication node 14.

In other embodiments, the synchronization signal occasion 16-O occurs in time before the wake-up signal occasion 20-O. In one or more of these embodiments, the method further comprises detecting the synchronization signal 16 (Block 610) and performing time and/or frequency synchronization based on the detected synchronization signal 16 (Block 620). In this case, monitoring for the wake-up signal 20 comprises monitoring for the wake-up signal 20 based on the performed time and/or frequency synchronization.

In still other embodiments, the synchronization signal occasion 16-O occurs in time after the wake-up signal occasion 20-O. In one or more of these embodiments, the method further comprises detecting the wake-up signal 20 during the wake-up signal occasion 20-O, and monitoring for the synchronization signal 16 (Block 600) is performed after detecting the wake-up signal 20 (Block 650). The method further comprises detecting the synchronization signal 16 (Block 610) as a result of monitoring for the synchronization signal 16, acquiring time and/or frequency synchronization based on the detected synchronization signal 16 (Block 620), and responsive to detecting the wake-up signal 20, waking up one or more components of a receiver of the first communication node 12 (Block 660). The method further comprises making use of the acquired time and/or frequency synchronization when operating the receiver (Block 630).

In some embodiments, the synchronization signal occasion 16-O and the wake-up signal occasion 20-O are consecutive occasions in time.

In other embodiments, a gap in time between the synchronization signal occasion 16-O and the wake-up signal occasion 20-O is a function of one or more of a cell identifier identifying a cell on which the first communication node 12 is to monitor for the synchronization signal 16, a carrier frequency on which the first communication node 12 to is monitor for the synchronization signal 16, a numerology or subcarrier spacing with which the first communication node 12 is to monitor for the synchronization signal 16, a periodicity of a wake-up signal occasion 20-O, or a discontinuous reception cycle length.

In some embodiments, the synchronization signal occasion 16-O recurs periodically in time with a period that is the same as a period with which the wake-up signal occasion 20-O recurs periodically in time. In other embodiments, the synchronization signal occasion 16-O recurs periodically in time with a period that is a multiple of a period with which the wake-up signal occasion 20-O recurs periodically in time.

In some embodiments, the synchronization signal occasion 16-O is commonly associated with a set of multiple group-specific wake-up signal occasions during which wake-up signals are transmittable for respective groups of first communication node 12s. In one or more of these embodiments, the synchronization signal occasion 16-O recurs periodically in time with a period that is a multiple of a period with which the set of multiple group-specific wake-up signal occasions recurs periodically in time.

In some embodiments, the synchronization signal occasion 16-O is associated with a group-specific wake-up signal occasion 20-O during which a wake-up signal 20 is transmittable for a specific group of first communication node 12s. In one or more of these embodiments, the synchronization signal occasion 16-O recurs periodically in time with a period that is a multiple of a period with which the group-specific wake-up signal occasion 20-O recurs periodically in time.

In some embodiments, the method further comprises determining a synchronization signal occasion 16-O during which to monitor for the synchronization signal 16. In one or more of these embodiments, determining the synchronization signal occasion 16-O comprises receiving information indicating the synchronization signal occasion 16-O. In one or more of these embodiments, the information is broadcasted System Information. In one or more of these embodiments, determining the synchronization signal occasion 16-O comprises determining the synchronization signal occasion 16-O based on one or more of a cell identifier identifying a cell on which the first communication node 12 is to monitor for the synchronization signal 16, a carrier frequency on which the first communication node 12 to is monitor for the synchronization signal 16, a numerology or subcarrier spacing with which the first communication node 12 is to monitor for the synchronization signal 16, a periodicity of a wake-up signal occasion 20-O, or a discontinuous reception cycle length.

In some embodiments, the method further comprises detecting the synchronization signal 16 (Block 610), and acquiring time and/or frequency synchronization with the second communication node 14 based on the detected synchronization signal 16 (Block 620).

In some embodiments, the method further comprises detecting a wake-up signal 20 (Block 650), and based on detecting the wake-up signal 20, waking up one or more components of a receiver of the first communication node 12 (Block 660).

In some embodiments, the synchronization signal 16 is based on a concatenation of a pair of Zadoff-Chu sequences with different roots. In one or more of these embodiments, the synchronization signal 16 is based on a pair of cyclic shifts applied to the pair of Zadoff-Chu sequences. In one or more of these embodiments, one Zadoff-Chu sequence in the pair is a complex conjugate of the other one of the Zadoff-Chu sequences in the pair. In one or more of these embodiments, the synchronization signal 16 is based on a first cyclic shift of each Zadoff-Chu sequence in a first pair of Zadoff-Chu sequences, and a wake-up signal 20 is based on a second cyclic shift of each Zadoff-Chu sequence in a second pair of Zadoff-Chu sequences. In one or more of these embodiments, the synchronization signal 16 is generated from a single binary sequence.

In some embodiments, monitoring comprises monitoring for the synchronization signal 16 in a synchronization signal occasion 16-O. In this case, the method further comprises monitoring for a wake-up signal 20 during a wake-up signal occasion 20-O, wherein the synchronization signal occasion 16-O and the wake-up signal occasion 20-O occur in the same frequency region.

In some embodiments, monitoring comprises monitoring for the synchronization signal 16 from the second communication node 14 with a wake-up receiver of the first communication node 12.

In some embodiments, the first communication node 12 is a wireless communication device.

In some embodiments, the first communication node 12 is a network node in a wireless communication network.

In some embodiments, the second communication node 14 is a network node in a wireless communication network.

In some embodiments, the second communication node 14 is a wireless communication device.

In some embodiments, the method further comprises providing user data, and forwarding the user data to a host computer via the transmission to a base station.

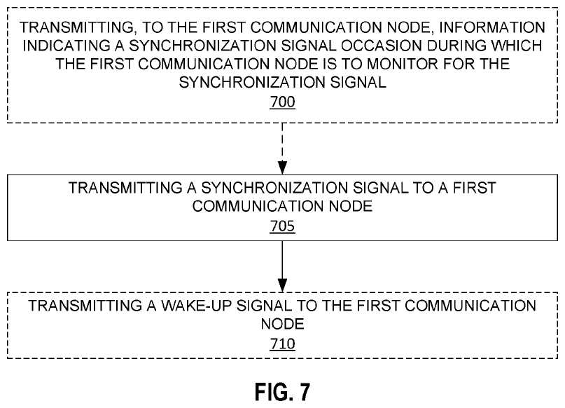

Other embodiments herein include a method performed by a second communication node 14 as shown in FIG. 7. The method comprises transmitting a synchronization signal 16 to a first communication node 12 (Block 705).

In some embodiments, transmitting a synchronization signal 16 comprises transmitting the synchronization signal 16 in a synchronization signal occasion 16-O.

In some embodiments, the method further comprises transmitting a wake-up signal 20, e.g., during a wake-up signal occasion 20-O (Block 710). In one or more of these embodiments, the wake-up signal occasion 20-O and the synchronization signal occasion 16-O at least partially overlap in time. In one or more of these embodiments, the synchronization signal occasion 16-O recurs periodically in time with a period that is the same as, or is a multiple of, a period with which the wake-up signal occasion 20-O recurs periodically in time. In this case, at least one recurrence of the wake-up signal occasion 20-O at least partially overlaps in time with at least one recurrence of the synchronization signal occasion 16-O.

In other embodiments, the synchronization signal occasion 16-O occurs in time before the wake-up signal occasion 20-O.

In yet other embodiments, the synchronization signal occasion 16-O occurs in time after the wake-up signal occasion 20-O.

In some embodiments, the synchronization signal occasion 16-O and the wake-up signal occasion 20-O are consecutive occasions in time. In other embodiments, a gap in time between the synchronization signal occasion 16-O and the wake-up signal occasion 20-O is a function of one or more of a cell identifier identifying a cell on which the first communication node 12 is to monitor for the synchronization signal 16, a carrier frequency on which the first communication node 12 to is monitor for the synchronization signal 16, a numerology or subcarrier spacing with which the first communication node 12 is to monitor for the synchronization signal 16, a periodicity of a wake-up signal occasion 20-0, or a discontinuous reception cycle length.

In some embodiments, the synchronization signal occasion 16-O recurs periodically in time with a period that is the same as a period with which the wake-up signal occasion 20-O recurs periodically in time. In other embodiments, the synchronization signal occasion 16-O recurs periodically in time with a period that is a multiple of a period with which the wake-up signal occasion 20-O recurs periodically in time.

In some embodiments, the synchronization signal occasion 16-O is commonly associated with a set of multiple group-specific wake-up signal occasions during which wake-up signals are transmittable for respective groups of first communication node 12s. In one or more of these embodiments, the synchronization signal occasion 16-O recurs periodically in time with a period that is a multiple of a period with which the set of multiple group-specific wake-up signal occasions recurs periodically in time.

In some embodiments, the synchronization signal occasion 16-O is associated with a group-specific wake-up signal occasion 20-O during which a wake-up signal 20 is transmittable for a specific group of first communication node 12s. In one or more of these embodiments, the synchronization signal occasion 16-O recurs periodically in time with a period that is a multiple of a period with which the group-specific wake-up signal occasion 20-O recurs periodically in time.

In some embodiments, the method further comprises transmitting, to the first communication node 12, information indicating a synchronization signal occasion 16-O during which the first communication node 12 is to monitor for the synchronization signal 16 (Block 700). In one or more of these embodiments, the information is System Information, and wherein transmitting the information comprises broadcasting the information. In one or more of these embodiments, the information indicates the synchronization signal occasion 16-O by indicating one or more of a cell identifier identifying a cell on which the first communication node 12 is to monitor for the synchronization signal 16, a carrier frequency on which the first communication node 12 to is monitor for the synchronization signal 16, a numerology or subcarrier spacing with which the first communication node 12 is to monitor for the synchronization signal 16, a periodicity of a wake-up signal occasion 20-O, or a discontinuous reception cycle length.

In some embodiments, the synchronization signal 16 is based on a concatenation of a pair of Zadoff-Chu sequences with different roots. In one or more of these embodiments, the synchronization signal 16 is based on a cyclic shift of each Zadoff-Chu sequence in the pair. In one or more of these embodiments, one Zadoff-Chu sequence in the pair is a complex conjugate of the other one of the Zadoff-Chu sequences in the pair. In one or more of these embodiments, the synchronization signal 16 is based on a first cyclic shift of each Zadoff-Chu sequence in a first pair of Zadoff-Chu sequences, and a wake-up signal 20 is based on a second cyclic shift of each Zadoff-Chu sequence in a second pair of Zadoff-Chu sequences. In one or more of these embodiments, the synchronization signal 16 is generated from a single binary sequence.

In some embodiments, the synchronization signal occasion 16-O and the wake-up signal occasion occur in the same frequency region.

In some embodiments, the synchronization signal 16 is receivable with a wake-up receiver of the first communication node 12.

In some embodiments, the first communication node 12 is a wireless communication device.

In some embodiments, the first communication node 12 is a network node in a wireless communication network.

In some embodiments, the second communication node 14 is a network node in a wireless communication network.

In some embodiments, the second communication node 14 is a wireless communication device.

In some embodiments, the method further comprises obtaining user data, and forwarding the user data to a host computer or a first communication node 12.

Embodiments herein also include corresponding apparatuses. Embodiments herein for instance include a first communication node 12 configured to perform any of the steps of any of the embodiments described above for the first communication node 12.

Embodiments also include a first communication node 12 comprising processing circuitry and power supply circuitry. The processing circuitry is configured to perform any of the steps of any of the embodiments described above for the first communication node 12. The power supply circuitry is configured to supply power to the first communication node 12.

Embodiments further include a first communication node 12 comprising processing circuitry. The processing circuitry is configured to perform any of the steps of any of the embodiments described above for the first communication node 12. In some embodiments, the first communication node 12 further comprises communication circuitry.

Embodiments further include a first communication node 12 comprising processing circuitry and memory. The memory contains instructions executable by the processing circuitry whereby the first communication node 12 is configured to perform any of the steps of any of the embodiments described above for the first communication node 12.

Embodiments moreover include a user equipment (UE). The UE comprises an antenna configured to send and receive wireless signals. The UE also comprises radio front-end circuitry connected to the antenna and to processing circuitry, and configured to condition signals communicated between the antenna and the processing circuitry. The processing circuitry is configured to perform any of the steps of any of the embodiments described above for the first communication node 12. In some embodiments, the UE also comprises an input interface connected to the processing circuitry and configured to allow input of information into the UE to be processed by the processing circuitry. The UE may comprise an output interface connected to the processing circuitry and configured to output information from the UE that has been processed by the processing circuitry. The UE may also comprise a battery connected to the processing circuitry and configured to supply power to the UE.

Embodiments herein also include a second communication node 14 configured to perform any of the steps of any of the embodiments described above for the second communication node 14.

Embodiments also include a second communication node 14 comprising processing circuitry and power supply circuitry. The processing circuitry is configured to perform any of the steps of any of the embodiments described above for the second communication node 14. The power supply circuitry is configured to supply power to the second communication node 14.

Embodiments further include a second communication node 14 comprising processing circuitry. The processing circuitry is configured to perform any of the steps of any of the embodiments described above for the second communication node 14. In some embodiments, the second communication node 14 further comprises communication circuitry.

Embodiments further include a second communication node 14 comprising processing circuitry and memory. The memory contains instructions executable by the processing circuitry whereby the second communication node 14 is configured to perform any of the steps of any of the embodiments described above for the second communication node 14.

More particularly, the apparatuses described above may perform the methods herein and any other processing by implementing any functional means, modules, units, or circuitry. In one embodiment, for example, the apparatuses comprise respective circuits or circuitry configured to perform the steps shown in the method figures. The circuits or circuitry in this regard may comprise circuits dedicated to performing certain functional processing and/or one or more microprocessors in conjunction with memory. For instance, the circuitry may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory may include program instructions for executing one or more telecommunications and/or data communications protocols as well as instructions for carrying out one or more of the techniques described herein, in several embodiments. In embodiments that employ memory, the memory stores program code that, when executed by the one or more processors, carries out the techniques described herein.

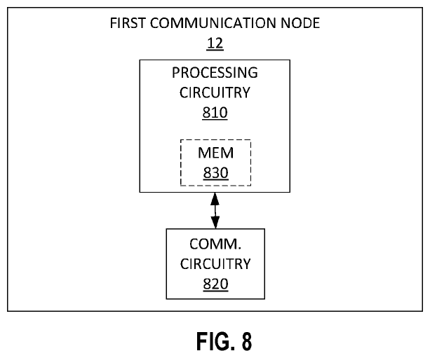

FIG. 8 for example illustrates a first communication node 12 as implemented in accordance with one or more embodiments. As shown, the first communication node 12 includes processing circuitry 810 and communication circuitry 820. The communication circuitry 820 (e.g., radio circuitry) is configured to transmit and/or receive information to and/or from one or more other nodes, e.g., via any communication technology. Such communication may occur via one or more antennas that are either internal or external to the wireless communication device 800. The processing circuitry 810 is configured to perform processing described above, e.g., in FIG. 6, such as by executing instructions stored in memory 830. The processing circuitry 810 in this regard may implement certain functional means, units, or modules.

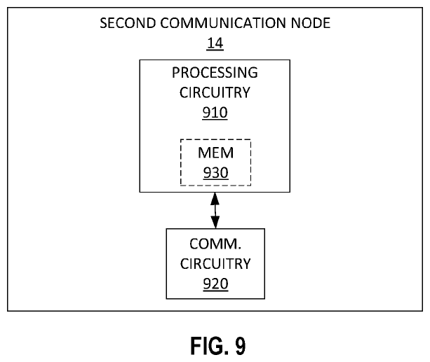

FIG. 9 illustrates a second communication node 14 as implemented in accordance with one or more embodiments. As shown, the second communication node 14 includes processing circuitry 910 and communication circuitry 920. The communication circuitry 920 is configured to transmit and/or receive information to and/or from one or more other nodes, e.g., via any communication technology. The processing circuitry 910 is configured to perform processing described above, e.g., in FIG. 7, such as by executing instructions stored in memory 930. The processing circuitry 910 in this regard may implement certain functional means, units, or modules.

Those skilled in the art will also appreciate that embodiments herein further include corresponding computer programs.

A computer program comprises instructions which, when executed on at least one processor of an apparatus, cause the apparatus to carry out any of the respective processing described above. A computer program in this regard may comprise one or more code modules corresponding to the means or units described above.

Embodiments further include a carrier containing such a computer program. This carrier may comprise one of an electronic signal, optical signal, radio signal, or computer readable storage medium.

In this regard, embodiments herein also include a computer program product stored on a non-transitory computer readable (storage or recording) medium and comprising instructions that, when executed by a processor of an apparatus, cause the apparatus to perform as described above.

Embodiments further include a computer program product comprising program code portions for performing the steps of any of the embodiments herein when the computer program product is executed by a computing device. This computer program product may be stored on a computer readable recording medium.

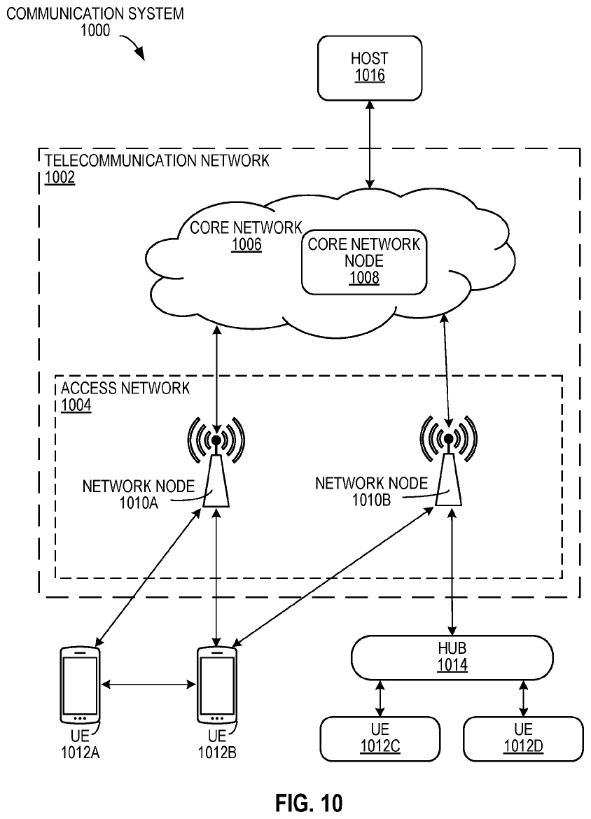

FIG. 10 shows an example of a communication system 1000 in accordance with some embodiments.

In the example, the communication system 1000 includes a telecommunication network 1002 that includes an access network 1004, such as a radio access network (RAN), and a core network 1006, which includes one or more core network nodes 1008. The access network 1004 includes one or more access network nodes, such as network nodes 1010a and 1010b (one or more of which may be generally referred to as network nodes 1010), or any other similar 3^{rd} Generation Partnership Project (3GPP) access node or non-3GPP access point. The network nodes 1010 facilitate direct or indirect connection of user equipment (UE), such as by connecting UEs 1012a, 1012b, 1012c, and 1012d (one or more of which may be generally referred to as UEs 1012) to the core network 1006 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1000 may include any number of wired or wireless networks, network nodes, UEs, and/or any other components or systems that may facilitate or participate in the communication of data and/or signals whether via wired or wireless connections. The communication system 1000 may include and/or interface with any type of communication, telecommunication, data, cellular, radio network, and/or other similar type of system.

The UEs 1012 may be any of a wide variety of communication devices, including wireless devices arranged, configured, and/or operable to communicate wirelessly with the network nodes 1010 and other communication devices. Similarly, the network nodes 1010 are arranged, capable, configured, and/or operable to communicate directly or indirectly with the UEs 1012 and/or with other network nodes or equipment in the telecommunication network 1002 to enable and/or provide network access, such as wireless network access, and/or to perform other functions, such as administration in the telecommunication network 1002.

In the depicted example, the core network 1006 connects the network nodes 1010 to one or more hosts, such as host 1016. These connections may be direct or indirect via one or more intermediary networks or devices. In other examples, network nodes may be directly coupled to hosts. The core network 1006 includes one more core network nodes (e.g., core network node 1008) that are structured with hardware and software components. Features of these components may be substantially similar to those described with respect to the UEs, network nodes, and/or hosts, such that the descriptions thereof are generally applicable to the corresponding components of the core network node 1008. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1016 may be under the ownership or control of a service provider other than an operator or provider of the access network 1004 and/or the telecommunication network 1002, and may be operated by the service provider or on behalf of the service provider. The host 1016 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1000 of FIG. 10 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1002 is a cellular network that implements 3GPP standardized features. Accordingly, the telecommunications network 1002 may support network slicing to provide different logical networks to different devices that are connected to the telecommunication network 1002. For example, the telecommunications network 1002 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1012 are configured to transmit and/or receive information without direct human interaction. For instance, a UE may be designed to transmit information to the access network 1004 on a predetermined schedule, when triggered by an internal or external event, or in response to requests from the access network 1004. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 1014 communicates with the access network 1004 to facilitate indirect communication between one or more UEs (e.g., UE 1012c and/or 1012d) and network nodes (e.g., network node 1010b). In some examples, the hub 1014 may be a controller, router, content source and analytics, or any of the other communication devices described herein regarding UEs. For example, the hub 1014 may be a broadband router enabling access to the core network 1006 for the UEs. As another example, the hub 1014 may be a controller that sends commands or instructions to one or more actuators in the UEs. Commands or instructions may be received from the UEs, network nodes 1010, or by executable code, script, process, or other instructions in the hub 1014. As another example, the hub 1014 may be a data collector that acts as temporary storage for UE data and, in some embodiments, may perform analysis or other processing of the data. As another example, the hub 1014 may be a content source. For example, for a UE that is a VR headset, display, loudspeaker or other media delivery device, the hub 1014 may retrieve VR assets, video, audio, or other media or data related to sensory information via a network node, which the hub 1014 then provides to the UE either directly, after performing local processing, and/or after adding additional local content. In still another example, the hub 1014 acts as a proxy server or orchestrator for the UEs, in particular in if one or more of the UEs are low energy IoT devices.

The hub 1014 may have a constant/persistent or intermittent connection to the network node 1010b. The hub 1014 may also allow for a different communication scheme and/or schedule between the hub 1014 and UEs (e.g., UE 1012c and/or 1012d), and between the hub 1014 and the core network 1006. In other examples, the hub 1014 is connected to the core network 1006 and/or one or more UEs via a wired connection. Moreover, the hub 1014 may be configured to connect to an M2M service provider over the access network 1004 and/or to another UE over a direct connection. In some scenarios, UEs may establish a wireless connection with the network nodes 1010 while still connected via the hub 1014 via a wired or wireless connection. In some embodiments, the hub 1014 may be a dedicated hub—that is, a hub whose primary function is to route communications to/from the UEs from/to the network node 1010b. In other embodiments, the hub 1014 may be a non-dedicated hub—that is, a device which is capable of operating to route communications between the UEs and network node 1010b, but which is additionally capable of operating as a communication start and/or end point for certain data channels.

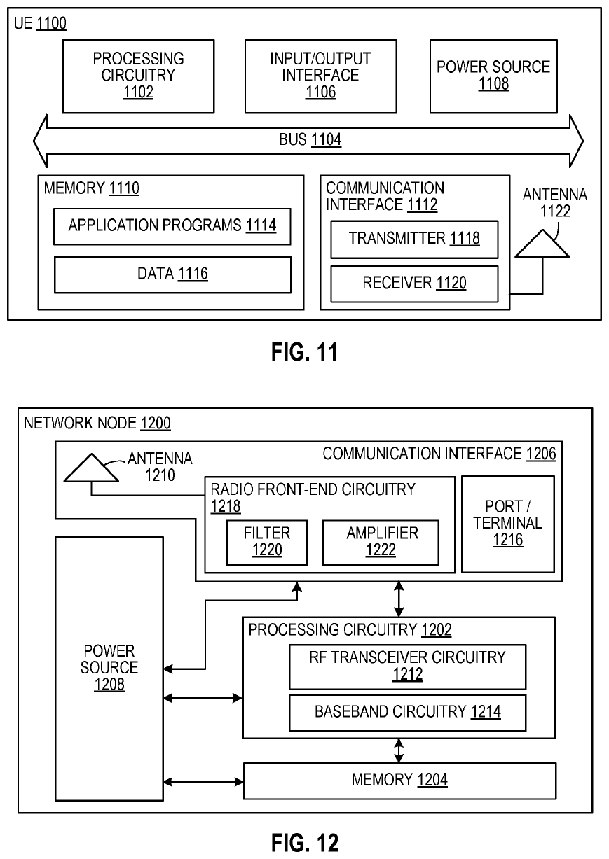

FIG. 11 shows a UE 1100 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1100 includes processing circuitry 1102 that is operatively coupled via a bus 1104 to an input/output interface 1106, a power source 1108, a memory 1110, a communication interface 1112, and/or any other component, or any combination thereof. Certain UEs may utilize all or a subset of the components shown in FIG. 11. The level of integration between the components may vary from one UE to another UE. Further, certain UEs may contain multiple instances of a component, such as multiple processors, memories, transceivers, transmitters, receivers, etc.

The processing circuitry 1102 is configured to process instructions and data and may be configured to implement any sequential state machine operative to execute instructions stored as machine-readable computer programs in the memory 1110. The processing circuitry 1102 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1102 may include multiple central processing units (CPUs).

In the example, the input/output interface 1106 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1100. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1108 is structured as a battery or battery pack. Other types of power sources, such as an external power source (e.g., an electricity outlet), photovoltaic device, or power cell, may be used. The power source 1108 may further include power circuitry for delivering power from the power source 1108 itself, and/or an external power source, to the various parts of the UE 1100 via input circuitry or an interface such as an electrical power cable. Delivering power may be, for example, for charging of the power source 1108. Power circuitry may perform any formatting, converting, or other modification to the power from the power source 1108 to make the power suitable for the respective components of the UE 1100 to which power is supplied.

The memory 1110 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1110 includes one or more application programs 1114, such as an operating system, web browser application, a widget, gadget engine, or other application, and corresponding data 1116. The memory 1110 may store, for use by the UE 1100, any of a variety of various operating systems or combinations of operating systems.

The memory 1110 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1110 may allow the UE 1100 to access instructions, application programs and the like, stored on transitory or non-transitory memory media, to off-load data, or to upload data. An article of manufacture, such as one utilizing a communication system may be tangibly embodied as or in the memory 1110, which may be or comprise a device-readable storage medium.

The processing circuitry 1102 may be configured to communicate with an access network or other network using the communication interface 1112. The communication interface 1112 may comprise one or more communication subsystems and may include or be communicatively coupled to an antenna 1122. The communication interface 1112 may include one or more transceivers used to communicate, such as by communicating with one or more remote transceivers of another device capable of wireless communication (e.g., another UE or a network node in an access network). Each transceiver may include a transmitter 1118 and/or a receiver 1120 appropriate to provide network communications (e.g., optical, electrical, frequency allocations, and so forth). Moreover, the transmitter 1118 and receiver 1120 may be coupled to one or more antennas (e.g., antenna 1122) and may share circuit components, software or firmware, or alternatively be implemented separately.

In the illustrated embodiment, communication functions of the communication interface 1112 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1112, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1100 shown in FIG. 11.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 12 shows a network node 1200 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1200 includes a processing circuitry 1202, a memory 1204, a communication interface 1206, and a power source 1208. The network node 1200 may be composed of multiple physically separate components (e.g., a NodeB component and a RNC component, or a BTS component and a BSC component, etc.), which may each have their own respective components. In certain scenarios in which the network node 1200 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1200 may be configured to support multiple radio access technologies (RATs). In such embodiments, some components may be duplicated (e.g., separate memory 1204 for different RATs) and some components may be reused (e.g., a same antenna 1210 may be shared by different RATs). The network node 1200 may also include multiple sets of the various illustrated components for different wireless technologies integrated into network node 1200, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1200.

The processing circuitry 1202 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1200 components, such as the memory 1204, to provide network node 1200 functionality.

In some embodiments, the processing circuitry 1202 includes a system on a chip (SOC). In some embodiments, the processing circuitry 1202 includes one or more of radio frequency (RF) transceiver circuitry 1212 and baseband processing circuitry 1214. In some embodiments, the radio frequency (RF) transceiver circuitry 1212 and the baseband processing circuitry 1214 may be on separate chips (or sets of chips), boards, or units, such as radio units and digital units. In alternative embodiments, part or all of RF transceiver circuitry 1212 and baseband processing circuitry 1214 may be on the same chip or set of chips, boards, or units.

The memory 1204 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1202. The memory 1204 may store any suitable instructions, data, or information, including a computer program, software, an application including one or more of logic, rules, code, tables, and/or other instructions capable of being executed by the processing circuitry 1202 and utilized by the network node 1200. The memory 1204 may be used to store any calculations made by the processing circuitry 1202 and/or any data received via the communication interface 1206. In some embodiments, the processing circuitry 1202 and memory 1204 is integrated.

The communication interface 1206 is used in wired or wireless communication of signaling and/or data between a network node, access network, and/or UE. As illustrated, the communication interface 1206 comprises port(s)/terminal(s) 1216 to send and receive data, for example to and from a network over a wired connection. The communication interface 1206 also includes radio front-end circuitry 1218 that may be coupled to, or in certain embodiments a part of, the antenna 1210. Radio front-end circuitry 1218 comprises filters 1220 and amplifiers 1222. The radio front-end circuitry 1218 may be connected to an antenna 1210 and processing circuitry 1202. The radio front-end circuitry may be configured to condition signals communicated between antenna 1210 and processing circuitry 1202. The radio front-end circuitry 1218 may receive digital data that is to be sent out to other network nodes or UEs via a wireless connection. The radio front-end circuitry 1218 may convert the digital data into a radio signal having the appropriate channel and bandwidth parameters using a combination of filters 1220 and/or amplifiers 1222. The radio signal may then be transmitted via the antenna 1210. Similarly, when receiving data, the antenna 1210 may collect radio signals which are then converted into digital data by the radio front-end circuitry 1218. The digital data may be passed to the processing circuitry 1202. In other embodiments, the communication interface may comprise different components and/or different combinations of components.

In certain alternative embodiments, the network node 1200 does not include separate radio front-end circuitry 1218, instead, the processing circuitry 1202 includes radio front-end circuitry and is connected to the antenna 1210. Similarly, in some embodiments, all or some of the RF transceiver circuitry 1212 is part of the communication interface 1206. In still other embodiments, the communication interface 1206 includes one or more ports or terminals 1216, the radio front-end circuitry 1218, and the RF transceiver circuitry 1212, as part of a radio unit (not shown), and the communication interface 1206 communicates with the baseband processing circuitry 1214, which is part of a digital unit (not shown).

The antenna 1210 may include one or more antennas, or antenna arrays, configured to send and/or receive wireless signals. The antenna 1210 may be coupled to the radio front-end circuitry 1218 and may be any type of antenna capable of transmitting and receiving data and/or signals wirelessly. In certain embodiments, the antenna 1210 is separate from the network node 1200 and connectable to the network node 1200 through an interface or port.

The antenna 1210, communication interface 1206, and/or the processing circuitry 1202 may be configured to perform any receiving operations and/or certain obtaining operations described herein as being performed by the network node. Any information, data and/or signals may be received from a UE, another network node and/or any other network equipment. Similarly, the antenna 1210, the communication interface 1206, and/or the processing circuitry 1202 may be configured to perform any transmitting operations described herein as being performed by the network node. Any information, data and/or signals may be transmitted to a UE, another network node and/or any other network equipment.

The power source 1208 provides power to the various components of network node 1200 in a form suitable for the respective components (e.g., at a voltage and current level needed for each respective component). The power source 1208 may further comprise, or be coupled to, power management circuitry to supply the components of the network node 1200 with power for performing the functionality described herein. For example, the network node 1200 may be connectable to an external power source (e.g., the power grid, an electricity outlet) via an input circuitry or interface such as an electrical cable, whereby the external power source supplies power to power circuitry of the power source 1208. As a further example, the power source 1208 may comprise a source of power in the form of a battery or battery pack which is connected to, or integrated in, power circuitry. The battery may provide backup power should the external power source fail.

Embodiments of the network node 1200 may include additional components beyond those shown in FIG. 12 for providing certain aspects of the network node's functionality, including any of the functionality described herein and/or any functionality necessary to support the subject matter described herein. For example, the network node 1200 may include user interface equipment to allow input of information into the network node 1200 and to allow output of information from the network node 1200. This may allow a user to perform diagnostic, maintenance, repair, and other administrative functions for the network node 1200.

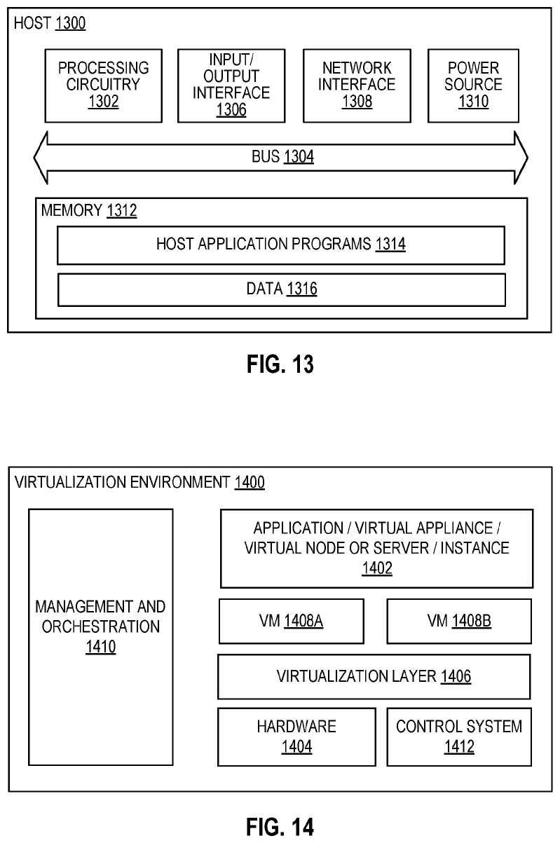

FIG. 13 is a block diagram of a host 1300, which may be an embodiment of the host 1016 of FIG. 10, in accordance with various aspects described herein. As used herein, the host 1300 may be or comprise various combinations hardware and/or software, including a standalone server, a blade server, a cloud-implemented server, a distributed server, a virtual machine, container, or processing resources in a server farm. The host 1300 may provide one or more services to one or more UEs.

The host 1300 includes processing circuitry 1302 that is operatively coupled via a bus 1304 to an input/output interface 1306, a network interface 1308, a power source 1310, and a memory 1312. Other components may be included in other embodiments. Features of these components may be substantially similar to those described with respect to the devices of previous figures, such as FIGS. 11 and 12, such that the descriptions thereof are generally applicable to the corresponding components of host 1300.

The memory 1312 may include one or more computer programs including one or more host application programs 1314 and data 1316, which may include user data, e.g., data generated by a UE for the host 1300 or data generated by the host 1300 for a UE. Embodiments of the host 1300 may utilize only a subset or all of the components shown. The host application programs 1314 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1314 may also provide for user authentication and licensing checks and may periodically report health, routes, and content availability to a central node, such as a device in or on the edge of a core network. Accordingly, the host 1300 may select and/or indicate a different host for over-the-top services for a UE. The host application programs 1314 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 14 is a block diagram illustrating a virtualization environment 1400 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1400 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1402 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1404 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1406 (also referred to as hypervisors or virtual machine monitors (VMMs)), provide VMs 1408a and 1408b (one or more of which may be generally referred to as VMs 1408), and/or perform any of the functions, features and/or benefits described in relation with some embodiments described herein. The virtualization layer 1406 may present a virtual operating platform that appears like networking hardware to the VMs 1408.

The VMs 1408 comprise virtual processing, virtual memory, virtual networking or interface and virtual storage, and may be run by a corresponding virtualization layer 1406. Different embodiments of the instance of a virtual appliance 1402 may be implemented on one or more of VMs 1408, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1408 may be a software implementation of a physical machine that runs programs as if they were executing on a physical, non-virtualized machine. Each of the VMs 1408, and that part of hardware 1404 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1408 on top of the hardware 1404 and corresponds to the application 1402.

Hardware 1404 may be implemented in a standalone network node with generic or specific components. Hardware 1404 may implement some functions via virtualization. Alternatively, hardware 1404 may be part of a larger cluster of hardware (e.g. such as in a data center or CPE) where many hardware nodes work together and are managed via management and orchestration 1410, which, among others, oversees lifecycle management of applications 1402. In some embodiments, hardware 1404 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1412 which may alternatively be used for communication between hardware nodes and radio units.

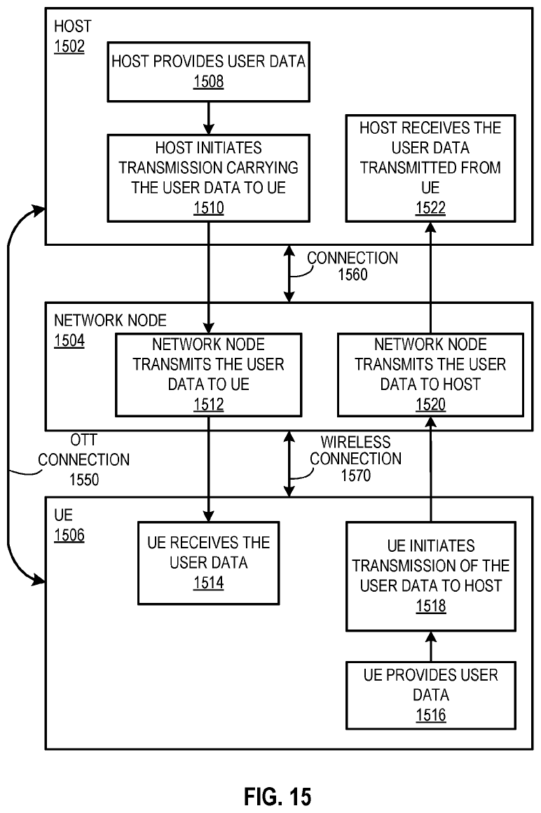

FIG. 15 shows a communication diagram of a host 1502 communicating via a network node 1504 with a UE 1506 over a partially wireless connection in accordance with some embodiments. Example implementations, in accordance with various embodiments, of the UE (such as a UE 1012a of FIG. 10 and/or UE 1100 of FIG. 11), network node (such as network node 1010a of FIG. 10 and/or network node 1200 of FIG. 12), and host (such as host 1016 of FIG. 10 and/or host 1300 of FIG. 13) discussed in the preceding paragraphs will now be described with reference to FIG. 15.

Like host 1300, embodiments of host 1502 include hardware, such as a communication interface, processing circuitry, and memory. The host 1502 also includes software, which is stored in or accessible by the host 1502 and executable by the processing circuitry. The software includes a host application that may be operable to provide a service to a remote user, such as the UE 1506 connecting via an over-the-top (OTT) connection 1550 extending between the UE 1506 and host 1502. In providing the service to the remote user, a host application may provide user data which is transmitted using the OTT connection 1550.

The network node 1504 includes hardware enabling it to communicate with the host 1502 and UE 1506. The connection 1560 may be direct or pass through a core network (like core network 1006 of FIG. 10) and/or one or more other intermediate networks, such as one or more public, private, or hosted networks. For example, an intermediate network may be a backbone network or the Internet.

The UE 1506 includes hardware and software, which is stored in or accessible by UE 1506 and executable by the UE's processing circuitry. The software includes a client application, such as a web browser or operator-specific “app” that may be operable to provide a service to a human or non-human user via UE 1506 with the support of the host 1502. In the host 1502, an executing host application may communicate with the executing client application via the OTT connection 1550 terminating at the UE 1506 and host 1502. In providing the service to the user, the UE's client application may receive request data from the host's host application and provide user data in response to the request data. The OTT connection 1550 may transfer both the request data and the user data. The UE's client application may interact with the user to generate the user data that it provides to the host application through the OTT connection 1550.

The OTT connection 1550 may extend via a connection 1560 between the host 1502 and the network node 1504 and via a wireless connection 1570 between the network node 1504 and the UE 1506 to provide the connection between the host 1502 and the UE 1506. The connection 1560 and wireless connection 1570, over which the OTT connection 1550 may be provided, have been drawn abstractly to illustrate the communication between the host 1502 and the UE 1506 via the network node 1504, without explicit reference to any intermediary devices and the precise routing of messages via these devices.

As an example of transmitting data via the OTT connection 1550, in step 1508, the host 1502 provides user data, which may be performed by executing a host application. In some embodiments, the user data is associated with a particular human user interacting with the UE 1506. In other embodiments, the user data is associated with a UE 1506 that shares data with the host 1502 without explicit human interaction. In step 1510, the host 1502 initiates a transmission carrying the user data towards the UE 1506. The host 1502 may initiate the transmission responsive to a request transmitted by the UE 1506. The request may be caused by human interaction with the UE 1506 or by operation of the client application executing on the UE 1506. The transmission may pass via the network node 1504, in accordance with the teachings of the embodiments described throughout this disclosure. Accordingly, in step 1512, the network node 1504 transmits to the UE 1506 the user data that was carried in the transmission that the host 1502 initiated, in accordance with the teachings of the embodiments described throughout this disclosure. In step 1514, the UE 1506 receives the user data carried in the transmission, which may be performed by a client application executed on the UE 1506 associated with the host application executed by the host 1502.

In some examples, the UE 1506 executes a client application which provides user data to the host 1502. The user data may be provided in reaction or response to the data received from the host 1502. Accordingly, in step 1516, the UE 1506 may provide user data, which may be performed by executing the client application. In providing the user data, the client application may further consider user input received from the user via an input/output interface of the UE 1506. Regardless of the specific manner in which the user data was provided, the UE 1506 initiates, in step 1518, transmission of the user data towards the host 1502 via the network node 1504. In step 1520, in accordance with the teachings of the embodiments described throughout this disclosure, the network node 1504 receives user data from the UE 1506 and initiates transmission of the received user data towards the host 1502. In step 1522, the host 1502 receives the user data carried in the transmission initiated by the UE 1506.

One or more of the various embodiments improve the performance of OTT services provided to the UE 1506 using the OTT connection 1550, in which the wireless connection 1570 forms the last segment.

In an example scenario, factory status information may be collected and analyzed by the host 1502. As another example, the host 1502 may process audio and video data which may have been retrieved from a UE for use in creating maps. As another example, the host 1502 may collect and analyze real-time data to assist in controlling vehicle congestion (e.g., controlling traffic lights). As another example, the host 1502 may store surveillance video uploaded by a UE. As another example, the host 1502 may store or control access to media content such as video, audio, VR or AR which it can broadcast, multicast or unicast to UEs. As other examples, the host 1502 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1550 between the host 1502 and UE 1506, in response to variations in the measurement results. The measurement procedure and/or the network functionality for reconfiguring the OTT connection may be implemented in software and hardware of the host 1502 and/or UE 1506. In some embodiments, sensors (not shown) may be deployed in or in association with other devices through which the OTT connection 1550 passes; the sensors may participate in the measurement procedure by supplying values of the monitored quantities exemplified above, or supplying values of other physical quantities from which software may compute or estimate the monitored quantities. The reconfiguring of the OTT connection 1550 may include message format, retransmission settings, preferred routing etc.; the reconfiguring need not directly alter the operation of the network node 1504. Such procedures and functionalities may be known and practiced in the art. In certain embodiments, measurements may involve proprietary UE signaling that facilitates measurements of throughput, propagation times, latency and the like, by the host 1502. The measurements may be implemented in that software causes messages to be transmitted, in particular empty or ‘dummy’ messages, using the OTT connection 1550 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

Notably, modifications and other embodiments of the present disclosure will come to mind to one skilled in the art having the benefit of the teachings presented in the foregoing descriptions and the associated drawings. Therefore, it is to be understood that the present disclosure is not to be limited to the specific embodiments disclosed and that modifications and other embodiments are intended to be included within the scope of this disclosure. Although specific terms may be employed herein, they are used in a generic and descriptive sense only and not for purposes of limitation.

Example embodiments of the techniques and apparatus described herein include, but are not limited to, the following enumerated examples:

### Group A Embodiments

A1. A method performed by a first communication node, the method comprising:
monitoring for a synchronization signal from a second communication node.
   A2. The method of embodiment A1, wherein said monitoring comprises monitoring for the synchronization signal in a synchronization signal occasion, and wherein the method further comprises monitoring for a wake-up signal during a wake-up signal occasion.
   A3. The method of embodiment A2, wherein the wake-up signal occasion and the synchronization signal occasion at least partially overlap in time.
   A4. The method of any of embodiments A2-A3, wherein the synchronization signal occasion recurs periodically in time with a period that is the same as, or is a multiple of, a period with which the wake-up signal occasion recurs periodically in time, wherein at least one recurrence of the wake-up signal occasion at least partially overlaps in time with at least one recurrence of the synchronization signal occasion.
   A5. The method of any of embodiments A3-A4, further comprising detecting the synchronization signal and, based on the detected synchronization signal, re-synchronizing with the second communication node to align a first time reference maintained by the first communication node with a second time reference maintained by the second communication node.
   A6. The method of embodiment A2, wherein the synchronization signal occasion occurs in time before the wake-up signal occasion.
   A7. The method of embodiment A6, further comprising:
detecting the synchronization signal as a result of said monitoring for the synchronization signal;
acquiring time and/or frequency synchronization based on the detected synchronization signal;
making use of the acquired time and/or frequency synchronization when operating a wake-up receiver of the first communication device; and
monitoring for a wake-up signal with the wake-up receiver.
   A8. The method of embodiment A2, wherein the synchronization signal occasion occurs in time after the wake-up signal occasion.
   A9. The method of embodiment A8, further comprising:
detecting the wake-up signal during the wake-up signal occasion, wherein said monitoring for the synchronization signal is performed after detecting the wake-up signal;
detecting the synchronization signal as a result of said monitoring for the synchronization signal;
acquiring time and/or frequency synchronization based on the detected synchronization signal;
responsive to detecting the wake-up signal, waking up one or more components of a receiver of the first communication node; and
making use of the acquired time and/or frequency synchronization when operating said receiver.
   A10. The method of any of embodiments A6-A9, wherein the synchronization signal occasion and the wake-up signal occasion are consecutive occasions in time.
   A11. The method of any of embodiments A6-A9, wherein a gap in time between the synchronization signal occasion and the wake-up signal occasion is a function of one or more of:
a cell identifier identifying a cell on which the first communication node is to monitor for the synchronization signal; or
a carrier frequency on which the first communication node to is monitor for the synchronization signal; or
a numerology or subcarrier spacing with which the first communication node is to monitor for the synchronization signal; or
a periodicity of a wake-up signal occasion; or
a discontinuous reception cycle length.
   A12. The method of any of embodiments A2-A11, wherein the synchronization signal occasion recurs periodically in time with a period that is the same as a period with which the wake-up signal occasion recurs periodically in time.
   A13. The method of any of embodiments A2-A11, wherein the synchronization signal occasion recurs periodically in time with a period that is a multiple of a period with which the wake-up signal occasion recurs periodically in time.
   A14. The method of any of embodiments A1-A11, wherein the synchronization signal occasion is commonly associated with a set of multiple group-specific wake-up signal occasions during which wake-up signals are transmittable for respective groups of first communication nodes.
   A15. The method of embodiment A14, wherein the synchronization signal occasion recurs periodically in time with a period that is a multiple of a period with which the set of multiple group-specific wake-up signal occasions recurs periodically in time.
   A16. The method of any of embodiments A1-A11, wherein the synchronization signal occasion is associated with a group-specific wake-up signal occasion during which a wake-up signal is transmittable for a specific group of first communication nodes.
   A17. The method of embodiment A16, wherein the synchronization signal occasion recurs periodically in time with a period that is a multiple of a period with which the group-specific wake-up signal occasion recurs periodically in time.
   A18. The method of any of embodiments A1-A17, further comprising determining a synchronization signal occasion during which to monitor for the synchronization signal.
   A19. The method of embodiment A18, wherein determining the synchronization signal occasion comprises receiving information indicating the synchronization signal occasion.
   A20. The method of embodiment A19, wherein the information is broadcasted System Information.
   A21. The method of embodiment A18, wherein determining the synchronization signal occasion comprises determining the synchronization signal occasion based on one or more of:
a cell identifier identifying a cell on which the first communication node is to monitor for the synchronization signal; or
a carrier frequency on which the first communication node to is monitor for the synchronization signal; or
a numerology or subcarrier spacing with which the first communication node is to monitor for the synchronization signal; or
a periodicity of a wake-up signal occasion; or
a discontinuous reception cycle length.
   A22. The method of any of embodiments A1-A21, further comprising:
detecting the synchronization signal; and
performing time and/or frequency synchronization with the second communication node based on the detected synchronization signal.
   A23. The method of any of embodiments A1-A22, wherein the method further comprises: detecting a wake-up signal; and
based on detecting the wake-up signal, waking up one or more components of a receiver of the first communication node.
   A24. The method of any of embodiments A1-A23, wherein the synchronization signal is based on a concatenation of a pair of Zadoff-Chu sequences with different roots.
   A25. The method of embodiment A24, wherein the synchronization signal is based on a pair of cyclic shifts applied to the pair of Zadoff-Chu sequences.
   A26. The method of any of embodiments A24-A25, wherein one Zadoff-Chu sequence in the pair is a complex conjugate of the other one of the Zadoff-Chu sequences in the pair.
   A27. The method of any of embodiments A24-A26, wherein the synchronization signal is based on a first cyclic shift of each Zadoff-Chu sequence in a first pair of Zadoff-Chu sequences, and wherein a wake-up signal is based on a second cyclic shift of each Zadoff-Chu sequence in a second pair of Zadoff-Chu sequences.
   A28. The method of any of embodiments A21-A27, wherein the synchronization signal is generated from a single binary sequence.
   A29. The method of any of embodiments A1-A28, wherein said monitoring comprises monitoring for the synchronization signal in a synchronization signal occasion, wherein the method further comprises monitoring for a wake-up signal during a wake-up signal occasion, wherein the synchronization signal occasion and the wake-up signal occasion occur in the same frequency region.
   A30. The method of any of embodiments A1-A29, wherein said monitoring comprises monitoring for the synchronization signal from the second communication node with a wake-up receiver of the first communication node.
   A31. The method of any of embodiments A1-A30, wherein the first communication node is a wireless communication device.
   A32. The method of any of embodiments A1-A30, wherein the first communication node is a network node in a wireless communication network.
   A33. The method of any of embodiments A1-A31, wherein the second communication node is a network node in a wireless communication network.
   A34. The method of any of embodiments A1-A31, wherein the second communication node is a wireless communication device.
   AA. The method of any of the previous embodiments, further comprising:
providing user data; and
forwarding the user data to a host computer via the transmission to a base station.

### Group B Embodiments

B1. A method performed by a second communication node, the method comprising:
transmitting a synchronization signal to a first communication node.
   B2. The method of embodiment B1, wherein said transmitting comprises transmitting the synchronization signal in a synchronization signal occasion, and wherein the method further comprises transmitting a wake-up signal during a wake-up signal occasion.
   B3. The method of embodiment B2, wherein the wake-up signal occasion and the synchronization signal occasion at least partially overlap in time.
   B4. The method of any of embodiments B2-B3, wherein the synchronization signal occasion recurs periodically in time with a period that is the same as, or is a multiple of, a period with which the wake-up signal occasion recurs periodically in time, wherein at least one recurrence of the wake-up signal occasion at least partially overlaps in time with at least one recurrence of the synchronization signal occasion.

### B5. Reserved.

B6. The method of embodiment B2, wherein the synchronization signal occasion occurs in time before the wake-up signal occasion.

### B7. Reserved.

B8. The method of embodiment B2, wherein the synchronization signal occasion occurs in time after the wake-up signal occasion.

### B9. Reserved.

B10. The method of any of embodiments B6-B9, wherein the synchronization signal occasion and the wake-up signal occasion are consecutive occasions in time.
B11. The method of any of embodiments B6-B10, wherein a gap in time between the synchronization signal occasion and the wake-up signal occasion is a function of one or more of
a cell identifier identifying a cell on which the first communication node is to monitor for the synchronization signal; or
a carrier frequency on which the first communication node to is monitor for the synchronization signal; or
a numerology or subcarrier spacing with which the first communication node is to monitor for the synchronization signal; or
a periodicity of a wake-up signal occasion; or
a discontinuous reception cycle length.
   B12. The method of any of embodiments B2-B11, wherein the synchronization signal occasion recurs periodically in time with a period that is the same as a period with which the wake-up signal occasion recurs periodically in time.
   B13. The method of any of embodiments B2-B11, wherein the synchronization signal occasion recurs periodically in time with a period that is a multiple of a period with which the wake-up signal occasion recurs periodically in time.
   B14. The method of any of embodiments B1-B11, wherein the synchronization signal occasion is commonly associated with a set of multiple group-specific wake-up signal occasions during which wake-up signals are transmittable for respective groups of first communication nodes.
   B15. The method of embodiment B14, wherein the synchronization signal occasion recurs periodically in time with a period that is a multiple of a period with which the set of multiple group-specific wake-up signal occasions recurs periodically in time.
   B16. The method of any of embodiments B1-B11, wherein the synchronization signal occasion is associated with a group-specific wake-up signal occasion during which a wake-up signal is transmittable for a specific group of first communication nodes.
   B17. The method of embodiment B16, wherein the synchronization signal occasion recurs periodically in time with a period that is a multiple of a period with which the group-specific wake-up signal occasion recurs periodically in time.
   B18. The method of any of embodiments B1-B17, further comprising transmitting, to the first communication node, information indicating a synchronization signal occasion during which the first communication node is to monitor for the synchronization signal.

### B19. Reserved.

B20. The method of embodiment B19, wherein the information is System Information, and wherein transmitting the information comprises broadcasting the information.
B21. The method of embodiment B18, wherein the information indicates the synchronization signal occasion by indicating one or more of:
a cell identifier identifying a cell on which the first communication node is to monitor for the synchronization signal; or
a carrier frequency on which the first communication node to is monitor for the synchronization signal; or
a numerology or subcarrier spacing with which the first communication node is to monitor for the synchronization signal; or
a periodicity of a wake-up signal occasion; or
a discontinuous reception cycle length.

### B22. Reserved.

### B23. Reserved.

B24. The method of any of embodiments B1-B21, wherein the synchronization signal is based on a concatenation of a pair of Zadoff-Chu sequences with different roots.
B25. The method of embodiment B24, wherein the synchronization signal is based on a cyclic shift of each Zadoff-Chu sequence in the pair.
B26. The method of any of embodiments B24-B25, wherein one Zadoff-Chu sequence in the pair is a complex conjugate of the other one of the Zadoff-Chu sequences in the pair.
B27. The method of any of embodiments B24-B26, wherein the synchronization signal is based on a first cyclic shift of each Zadoff-Chu sequence in a first pair of Zadoff-Chu sequences, and wherein a wake-up signal is based on a second cyclic shift of each Zadoff-Chu sequence in a second pair of Zadoff-Chu sequences.
B28. The method of any of embodiments B21-BA27, wherein the synchronization signal is generated from a single binary sequence.
B29. The method of any of embodiments B1-B28, wherein the synchronization signal occasion and the wake-up signal occasion occur in the same frequency region.
B30. The method of any of embodiments B1-B29, wherein the synchronization signal is receivable with a wake-up receiver of the first communication node.
B31. The method of any of embodiments B1-B30, wherein the first communication node is a wireless communication device.
B32. The method of any of embodiments B1-B30, wherein the first communication node is a network node in a wireless communication network.
B33. The method of any of embodiments B1-B31, wherein the second communication node is a network node in a wireless communication network.
B34. The method of any of embodiments B1-B31, wherein the second communication node is a wireless communication device.
BB. The method of any of the previous embodiments, further comprising:
obtaining user data; and
forwarding the user data to a host computer or a first communication node.

### Group C Embodiments

C1. A first communication node configured to perform any of the steps of any of the Group A embodiments.
C2. A first communication node comprising processing circuitry configured to perform any of the steps of any of the Group A embodiments.
C3. A first communication node comprising:
communication circuitry; and
processing circuitry configured to perform any of the steps of any of the Group A embodiments.
   C4. A first communication node comprising:
processing circuitry configured to perform any of the steps of any of the Group A embodiments; and
power supply circuitry configured to supply power to the first communication node.
   C5. A first communication node comprising:
processing circuitry and memory, the memory containing instructions executable by the processing circuitry whereby the first communication node is configured to perform any of the steps of any of the Group A embodiments.
   C6. A user equipment (UE) comprising:
an antenna configured to send and receive wireless signals;
radio front-end circuitry connected to the antenna and to processing circuitry, and configured to condition signals communicated between the antenna and the processing circuitry;
the processing circuitry being configured to perform any of the steps of any of the Group A embodiments;
an input interface connected to the processing circuitry and configured to allow input of information into the UE to be processed by the processing circuitry;
an output interface connected to the processing circuitry and configured to output information from the UE that has been processed by the processing circuitry; and
a battery connected to the processing circuitry and configured to supply power to the UE.
   C7. A computer program comprising instructions which, when executed by at least one processor of a first communication node, causes the first communication node to carry out the steps of any of the Group A embodiments.
   C8. A carrier containing the computer program of embodiment C7, wherein the carrier is one of an electronic signal, optical signal, radio signal, or computer readable storage medium.
   C9. A second communication node configured to perform any of the steps of any of the Group B embodiments.
   C10. A second communication node comprising processing circuitry configured to perform any of the steps of any of the Group B embodiments.
   C11. A second communication node comprising:
communication circuitry; and
processing circuitry configured to perform any of the steps of any of the Group B embodiments.
   C12. A second communication node comprising:
processing circuitry configured to perform any of the steps of any of the Group B embodiments;
power supply circuitry configured to supply power to the second communication node.
   C13. A second communication node comprising:
processing circuitry and memory, the memory containing instructions executable by the processing circuitry whereby the second communication node is configured to perform any of the steps of any of the Group B embodiments.
   C14. The second communication node of any of embodiments C9-C13, wherein the second communication node is a base station.
   C15. A computer program comprising instructions which, when executed by at least one processor of a second communication node, causes the second communication node to carry out the steps of any of the Group B embodiments.
   C16. The computer program of embodiment C14, wherein the second communication node is a base station.
   C17. A carrier containing the computer program of any of embodiments C15-C16, wherein the carrier is one of an electronic signal, optical signal, radio signal, or computer readable storage medium.

### Group D Embodiments

D1. A communication system including a host computer comprising:
processing circuitry configured to provide user data; and
a communication interface configured to forward the user data to a cellular network for transmission to a user equipment (UE),
wherein the cellular network comprises a base station having a radio interface and processing circuitry, the base station's processing circuitry configured to perform any of the steps of any of the Group B embodiments.
   D2. The communication system of the previous embodiment further including the base station.
   D3. The communication system of the previous 2 embodiments, further including the UE, wherein the UE is configured to communicate with the base station.
   D4. The communication system of the previous 3 embodiments, wherein:
the processing circuitry of the host computer is configured to execute a host application, thereby providing the user data; and
the UE comprises processing circuitry configured to execute a client application associated with the host application.
   D5. A method implemented in a communication system including a host computer, a base station and a user equipment (UE), the method comprising:
at the host computer, providing user data; and
at the host computer, initiating a transmission carrying the user data to the UE via a cellular network comprising the base station, wherein the base station performs any of the steps of any of the Group B embodiments.
   D6. The method of the previous embodiment, further comprising, at the base station, transmitting the user data.
   D7. The method of the previous 2 embodiments, wherein the user data is provided at the host computer by executing a host application, the method further comprising, at the UE, executing a client application associated with the host application.
   D8. A user equipment (UE) configured to communicate with a base station, the UE comprising a radio interface and processing circuitry configured to perform any of the previous 3 embodiments.
   D9. A communication system including a host computer comprising:
processing circuitry configured to provide user data; and
a communication interface configured to forward user data to a cellular network for transmission to a user equipment (UE),
wherein the UE comprises a radio interface and processing circuitry, the UE's components configured to perform any of the steps of any of the Group A embodiments.
   D10. The communication system of the previous embodiment, wherein the cellular network further includes a base station configured to communicate with the UE.
   D11. The communication system of the previous 2 embodiments, wherein:
the processing circuitry of the host computer is configured to execute a host application, thereby providing the user data; and
the UE's processing circuitry is configured to execute a client application associated with the host application.
   D12. A method implemented in a communication system including a host computer, a base station and a user equipment (UE), the method comprising:
at the host computer, providing user data; and
at the host computer, initiating a transmission carrying the user data to the UE via a cellular network comprising the base station, wherein the UE performs any of the steps of any of the Group A embodiments.
   D13. The method of the previous embodiment, further comprising at the UE, receiving the user data from the base station.
   D14. A communication system including a host computer comprising:
communication interface configured to receive user data originating from a transmission from a user equipment (UE) to a base station,
wherein the UE comprises a radio interface and processing circuitry, the UE's processing circuitry configured to perform any of the steps of any of the Group A embodiments.
   D15. The communication system of the previous embodiment, further including the UE.
   D16. The communication system of the previous 2 embodiments, further including the base station, wherein the base station comprises a radio interface configured to communicate with the UE and a communication interface configured to forward to the host computer the user data carried by a transmission from the UE to the base station.
   D17. The communication system of the previous 3 embodiments, wherein:
the processing circuitry of the host computer is configured to execute a host application; and
the UE's processing circuitry is configured to execute a client application associated with the host application, thereby providing the user data.
   D18. The communication system of the previous 4 embodiments, wherein:
the processing circuitry of the host computer is configured to execute a host application, thereby providing request data; and
the UE's processing circuitry is configured to execute a client application associated with the host application, thereby providing the user data in response to the request data.
   D19. A method implemented in a communication system including a host computer, a base station and a user equipment (UE), the method comprising:
at the host computer, receiving user data transmitted to the base station from the UE, wherein the UE performs any of the steps of any of the Group A embodiments.
   D20. The method of the previous embodiment, further comprising, at the UE, providing the user data to the base station.
   D21. The method of the previous 2 embodiments, further comprising:
at the UE, executing a client application, thereby providing the user data to be transmitted; and
at the host computer, executing a host application associated with the client application.
   D22. The method of the previous 3 embodiments, further comprising:
at the UE, executing a client application; and
at the UE, receiving input data to the client application, the input data being provided at the host computer by executing a host application associated with the client application,
wherein the user data to be transmitted is provided by the client application in response to the input data.
   D23. A communication system including a host computer comprising a communication interface configured to receive user data originating from a transmission from a user equipment (UE) to a base station, wherein the base station comprises a radio interface and processing circuitry, the base station's processing circuitry configured to perform any of the steps of any of the Group B embodiments.
   D24. The communication system of the previous embodiment further including the base station.
   D25. The communication system of the previous 2 embodiments, further including the UE, wherein the UE is configured to communicate with the base station.
   D26. The communication system of the previous 3 embodiments, wherein:
the processing circuitry of the host computer is configured to execute a host application;
the UE is configured to execute a client application associated with the host application, thereby providing the user data to be received by the host computer.
   D27. A method implemented in a communication system including a host computer, a base station and a user equipment (UE), the method comprising:
at the host computer, receiving, from the base station, user data originating from a transmission which the base station has received from the UE, wherein the UE performs any of the steps of any of the Group A embodiments.
   D28. The method of the previous embodiment, further comprising at the base station, receiving the user data from the UE.
   D29. The method of the previous 2 embodiments, further comprising at the base station, initiating a transmission of the received user data to the host computer.

1.-37. (canceled)

38. A method performed by a first communication node, the method comprising:
monitoring for a wake-up signal during a wake-up signal occasion; and
monitoring for a synchronization signal in a synchronization signal occasion that:
at least partially overlaps in time with the wake-up signal occasion; or
occurs in time before or after the wake-up signal occasion, wherein either the synchronization signal occasion and the wake-up signal occasion are consecutive occasions in time or a gap in time between the synchronization signal occasion and the wake-up signal occasion is a function of one or more of:
a cell identifier identifying a cell on which the first communication node is to monitor for the synchronization signal; or
a carrier frequency on which the first communication node to is monitor for the synchronization signal; or
a numerology or subcarrier spacing with which the first communication node is to monitor for the synchronization signal; or
a periodicity of the wake-up signal occasion; or
a discontinuous reception cycle length.

39. The method of claim 38, wherein the synchronization signal occasion at least partially overlaps in time with the wake-up signal occasion, wherein the synchronization signal occasion recurs periodically in time with a period that is the same as, or is a multiple of, a period with which the wake-up signal occasion recurs periodically in time, wherein at least one recurrence of the wake-up signal occasion at least partially overlaps in time with at least one recurrence of the synchronization signal occasion.

40. The method of claim 38, wherein the synchronization signal occasion occurs in time before the wake-up signal occasion, wherein the method further comprises:
detecting the synchronization signal as a result of said monitoring for the synchronization signal;
acquiring time and/or frequency synchronization based on the detected synchronization signal; and
making use of the acquired time and/or frequency synchronization when operating a wake-up receiver of the first communication device;
wherein monitoring for the wake-up signal comprises monitoring for the wake-up signal with the wake-up receiver.

41. The method of claim 38, wherein the synchronization signal occasion occurs in time after the wake-up signal occasion, wherein the method further comprises:
detecting the wake-up signal during the wake-up signal occasion, wherein said monitoring for the synchronization signal is performed after detecting the wake-up signal;
detecting the synchronization signal as a result of said monitoring for the synchronization signal;
acquiring time and/or frequency synchronization based on the detected synchronization signal;
responsive to detecting the wake-up signal, waking up one or more components of a receiver of the first communication node; and
making use of the acquired time and/or frequency synchronization when operating said receiver.

42. The method of claim 38, wherein the synchronization signal occasion and the wake-up signal occasion are consecutive occasions in time.

43. The method of claim 38, wherein a gap in time between the synchronization signal occasion and the wake-up signal occasion is a function of one or more of:
a cell identifier identifying a cell on which the first communication node is to monitor for the synchronization signal; or
a carrier frequency on which the first communication node to is monitor for the synchronization signal; or
a numerology or subcarrier spacing with which the first communication node is to monitor for the synchronization signal; or
a periodicity of a wake-up signal occasion; or
a discontinuous reception cycle length.

44. The method of claim 38, further comprising detecting the synchronization signal from a second communication node and, based on the detected synchronization signal, re-synchronizing with the second communication node to align a first time reference maintained by the first communication node with a second time reference maintained by the second communication node.

45. The method of claim 38, further comprising:
detecting the wake-up signal;
based on detecting the wake-up signal, waking up one or more components of a receiver of the first communication node;
detecting the synchronization signal from a second communication node as a result of said monitoring for the synchronization signal; and
performing time and/or frequency synchronization with the second communication node based on the detected synchronization signal.

46. The method of claim 38, wherein said monitoring comprises monitoring for the synchronization signal with a wake-up receiver of the first communication node.

47. The method of claim 38, wherein monitoring for the synchronization signal comprises monitoring for a synchronization signal that is generated from a single binary sequence or is based on a concatenation of a pair of Zadoff-Chu sequences with different roots.

48. The method of claim 47, wherein the synchronization signal is based on a pair of cyclic shifts applied to the pair of Zadoff-Chu sequences.

49. The method of claim 47, wherein one Zadoff-Chu sequence in the pair is a complex conjugate of the other one of the Zadoff-Chu sequences in the pair.

50. The method of claim 47, wherein the synchronization signal is based on a first cyclic shift of each Zadoff-Chu sequence in a first pair of Zadoff-Chu sequences, and wherein a wake-up signal is based on a second cyclic shift of each Zadoff-Chu sequence in a second pair of Zadoff-Chu sequences.

51. A method performed by a second communication node, the method comprising:
transmitting, to a first communication node, a wake-up signal during a wake-up signal occasion; and
transmitting, to the first communication node, a synchronization signal in a synchronization signal occasion that:
at least partially overlaps in time with the wake-up signal occasion; or
occurs in time before or after the wake-up signal occasion, wherein either the synchronization signal occasion and the wake-up signal occasion are consecutive occasions in time or a gap in time between the synchronization signal occasion and the wake-up signal occasion is a function of one or more of:
a cell identifier identifying a cell on which the synchronization signal is transmitted; or
a carrier frequency on which the synchronization signal is transmitted; or
a numerology or subcarrier spacing with which the synchronization signal is transmitted; or
a periodicity of the wake-up signal occasion; or
a discontinuous reception cycle length.

52. The method of claim 51, wherein the synchronization signal occasion at least partially overlaps in time with the wake-up signal occasion, wherein the synchronization signal occasion recurs periodically in time with a period that is the same as, or is a multiple of, a period with which the wake-up signal occasion recurs periodically in time, wherein at least one recurrence of the wake-up signal occasion at least partially overlaps in time with at least one recurrence of the synchronization signal occasion.

53. The method of claim 51, wherein the synchronization signal occasion occurs in time before the wake-up signal occasion.

54. The method of claim 51, wherein the synchronization signal occasion occurs in time after the wake-up signal occasion.

55. The method of claim 51, wherein the synchronization signal occasion and the wake-up signal occasion are consecutive occasions in time.

56. A first communication node comprising:
communication circuitry; and
processing circuitry configured to:
monitor for a wake-up signal during a wake-up signal occasion; and
monitor for a synchronization signal in a synchronization signal occasion that:
at least partially overlaps in time with the wake-up signal occasion; or
occurs in time before or after the wake-up signal occasion, wherein either the synchronization signal occasion and the wake-up signal occasion are consecutive occasions in time or a gap in time between the synchronization signal occasion and the wake-up signal occasion is a function of one or more of:
a cell identifier identifying a cell on which the first communication node is to monitor for the synchronization signal; or
a carrier frequency on which the first communication node to is monitor for the synchronization signal; or
a numerology or subcarrier spacing with which the first communication node is to monitor for the synchronization signal; or
a periodicity of the wake-up signal occasion; or
a discontinuous reception cycle length.

57. A second communication node comprising:
communication circuitry; and
processing circuitry configured to:
transmit, to a first communication node, a wake-up signal during a wake-up signal occasion; and
transmit, to the first communication node, a synchronization signal in a synchronization signal occasion that:
at least partially overlaps in time with the wake-up signal occasion; or
occurs in time before or after the wake-up signal occasion, wherein either the synchronization signal occasion and the wake-up signal occasion are consecutive occasions in time or a gap in time between the synchronization signal occasion and the wake-up signal occasion is a function of one or more of:
a cell identifier identifying a cell on which the synchronization signal is transmitted; or
a carrier frequency on which the synchronization signal is transmitted; or
a numerology or subcarrier spacing with which the synchronization signal is transmitted; or
a periodicity of the wake-up signal occasion; or
a discontinuous reception cycle length.
